(19) United States
(12) Patent Application Publication
(10) Pub. No.: US 2025/0282228 A1
(43) Pub. Date: Sep. 11, 2025

(54) DRIVING DYNAMICS SYSTEM, VEHICLE AND METHOD FOR OPERATING A DRIVING DYNAMICS SYSTEM

(71) Applicant: IPGATE AG, Pfaffikon (CH)

(72) Inventor: Thomas LEIBER, Rogoznica (HR)

(21) Appl. No.: 18/862,385

(22) PCT Filed: May 4, 2023
(86) PCT No.: PCT/EP2023/061819

§ 371 Date: Nov. 1, 2024

(30) Foreign Application Priority Data
May 5, 2022 (DE) 10 2022 111 061.3

(51) Int. Cl. B60L 7/26; B60L 3/10

(52) U.S. Cl. CPC B60L 7/26; B60L 3/108; B60L 2240/12; B60L 2240/16; B60L 2240/22; B60L 2240/26; B60L 2240/36; B60L 2240/423; B60L 2240/461; B60L 2240/647

(57) ABSTRACT

A driving dynamics system for a vehicle may include at least one wheel brake for dissipative braking of a wheel of the vehicle; at least one braking unit associated with the at least one wheel brake and designed to generate a dissipative braking torque via the at least one wheel brake; at least one electric traction motor controllable to generate a regenerative braking torque for at least one wheel or axle of the vehicle; and a central control unit configured to control the at least one brake unit and the at least one electric traction motor for a braking function in combination such that a combined braking torque is generated by means of the at least one brake unit and the at least one electric traction motor. The braking function relates to simultaneous control of a basic braking torque and a controlled additional braking torque.

The present invention relates to a driving dynamics system (DDS) with one or more electric traction motor(s) and a powerful central processor, electric traction motor(s) and brake modules (EMB, EHB) being controlled synchronously via the central processor in such a way that the traction motor(s) and brake module(s) (EMB, EHB) are controlled together in the basic brake and control mode function. It further relates to a vehicle with a driving dynamics system and to a method for operating the driving dynamics system.

Preferably, the brake and electric traction motors are combined as wheel modules or electric vehicle axle modules, with the wheel brake and electric traction motor being controlled synchronously via another wheel or axle module control unit.

The automotive industry is undergoing a process of disruptive change. In addition to the increasing market penetration of electric vehicles, various stages of automated driving are being implemented, including, in particular: Level 3-Highly Automated Driving (HAD), Level 4-Fully Automated Driving (FAD), and Level 5-Autonomous Driving (AD), with each level involving greater demands being placed on the systems used to control driving dynamics.

From level 4 (FAD) onward, at least 2-fold, preferably 3-fold redundancy is expected for sufficient system availability, e.g., for pedal sensors with the “2-out-of-3” rule. Furthermore, redundant wheel-specific braking torque control is required for automated driving starting at level 3, and especially from level 4 onward. In level 5 (AD), the steering wheel and brake and accelerator pedals may be completely eliminated, and the vehicle is controlled exclusively by a central processor. Since the driver can no longer intervene via a brake pedal or steering wheel in the event of a system failure, a fail-safe 2-way or 3-way redundancy with degradation of all core functions of the brakes (brake booster, ABS, vehicle stabilization) and steering is required.

In addition, the domain structure is introduced with control units/domains for chassis control, which includes the brakes, electric drive, steering, and optionally also the damping system. Through the central control system, the vehicle manufacturer assumes responsibility for the abovementioned units and is therefore also able to optimally exploit synergies. At the same time, however, it must ensure the necessary redundancies, because new requirements must be met due to the transfer of liability from the driver of the vehicle to the manufacturer of the vehicle. In addition, vehicles of autonomous driving levels 3-5 should not be parked on the side of the road; at least a limp-home mode is more than desirable, and even a continuation of operation in the event of a partial failure is more desirable still, since autonomous vehicles aim for a long service life.

Electrohydraulic brake (EHB) systems or electromechanical brakes (EMB) as well as foundation brakes with brake shoes and brake discs are available as friction brake systems. Compared to EHBs, EMBs have the disadvantage of higher costs, since an EMB is required for each wheel; however, they offer the advantage that the EMBs can be controlled centrally much more easily, since a central driving dynamics control system DDS with ABS and ESP function can be developed independently of brake manufacturers, and the integration into the domain and application of an electromechanical brake is much easier than with an electrohydraulic brake. This is especially true when compared to standard ABS systems with open brake circuits, where very complex and adaptively learning pressure estimation models are required. The increasingly widespread use of EMB is therefore not primarily motivated by unit costs, but rather it is driven by lower application effort and simpler integration.

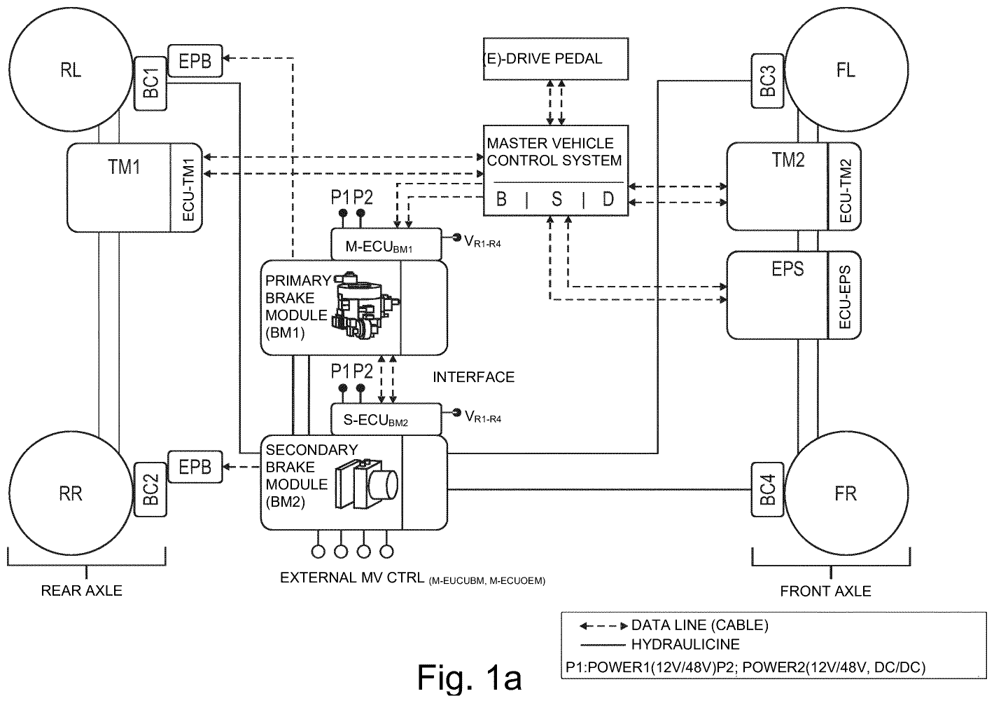

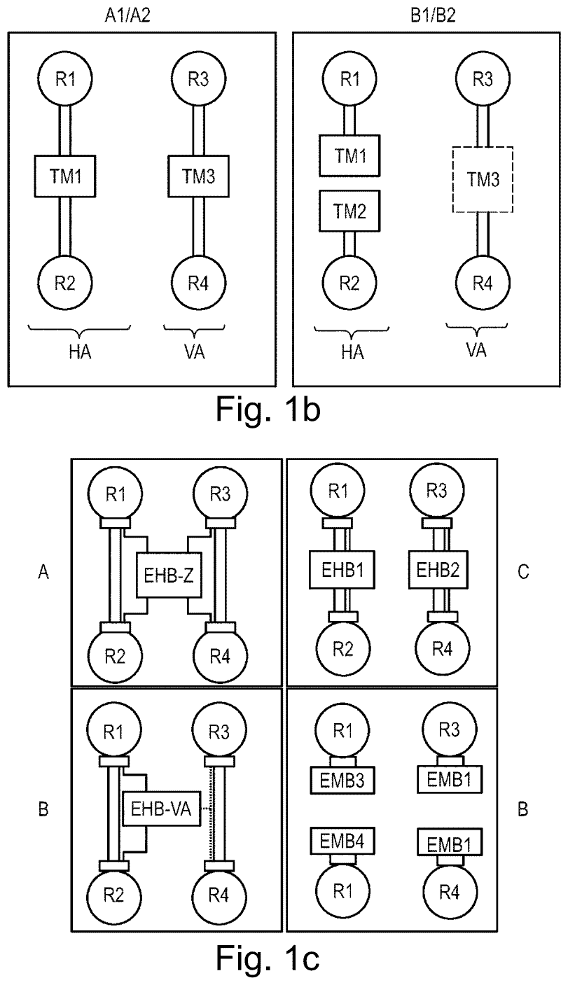

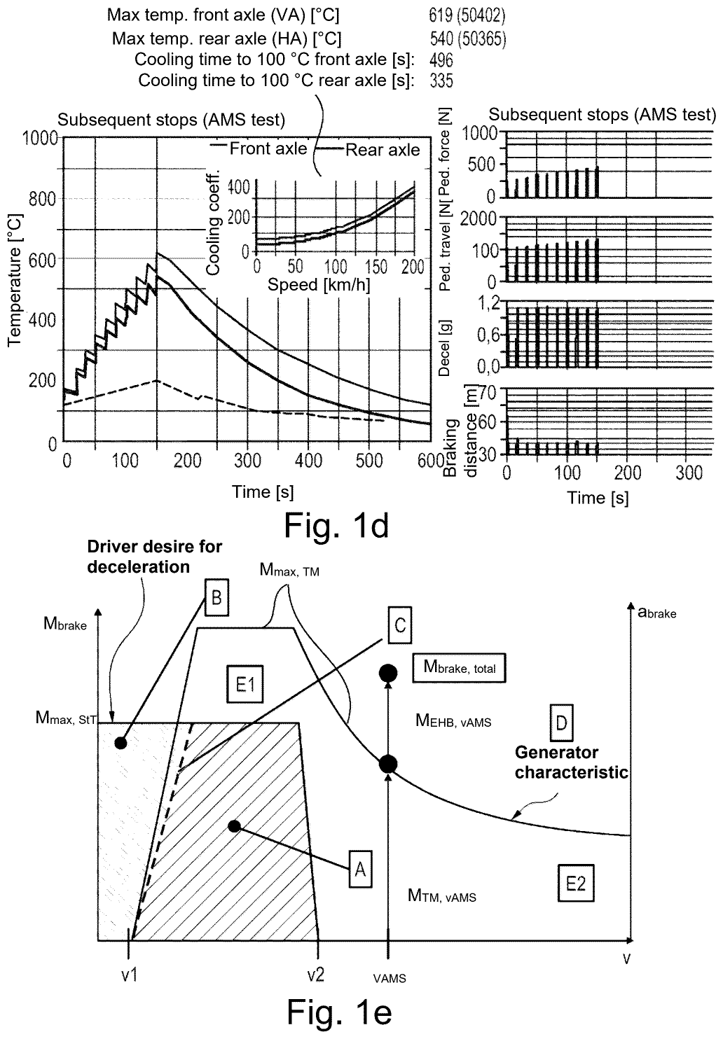

A typical vehicle architecture with electric drives for SAE Level 3-4 is shown in FIG. 1a (FIG. 1a was taken from here: https://www.Isp-ias.com/our-world/chassis-control). Here, according to WO 2019/214833 A1, for example, an electric friction braking system with a brake booster and an ESP unit is used.

Furthermore, it is known from WO 2019/002475 A1 that the brake can be controlled as a pressure actuator, controlled centrally via a central processor, namely a domain, so that the braking torques are determined in the central processor and the electrohydraulic brake only serves as a pressure actuator for effecting a target braking torque or a target pressure.

Furthermore, an electrohydraulic braking system is known from WO 2020/165255 A1 in which, in the event of failure or partial failure of the pressure supply device, braking is carried out or assisted by an electric traction motor and/or an electric parking brake.

Furthermore, the so-called combi brake is known from WO 2019/215278 A2 in which an electrohydraulic brake (EHB) is used on the front axle and an electromechanical brake (EMB) or a hydraulically assisted electromechanical brake (H-EMB) is used on the rear axle.

WO 2020/128081 discloses an electric axle module in which a pressure actuator supplies the hydraulic consumers, in particular the hydraulic wheel brake, with pressure.

WO 2018/215397 A1 discloses the idea of a central control for the electric motor and electrohydraulic brake, with a focus on a minimum time to reach the locking pressure (time-to-lock, or TTL). In addition, a braking function exclusively via the electric traction motor is introduced as a function of the driving situation through the use of a vehicle model.

In WO 2021/037658A1, another idea for the central control of the electric traction motor and electrohydraulic brake is disclosed, namely the central control of the electric brakeforce distribution with simultaneous recuperation via the electric motor.

A holistic optimization of the driving dynamics control as well as a cost reduction through the use of synergies of EMB or EHB combined with electric traction motors has only been investigated rudimentarily in the prior art, since brake-by-wire braking and braking via electric traction motors are regarded as separate units, and braking by electric traction motors has been limited to a deceleration of approx. 0.3 g for safety and liability reasons, in particular to avoid safety-critical driving situations. Furthermore, batteries are technically limited in their ability to absorb energy, particularly at a full battery state of charge (SOC), when regenerative energy is generated via the electric traction motor, which requires an energy sink. The synergy potential of a joint use between drive motors and brakes is very high, because electric drive motors are becoming increasingly more powerful and dynamic in the development of electric vehicles by virtue of high-voltage technology (particularly 400 V or 800 V) and therefore have the potential to make a substantial contribution to shortening braking distances. In particular, the combined use of electric traction motors in highly dynamic braking control processes, especially ABS control, offers great potential for new, innovative approaches.

In addition, the potential for downsizing and cost reduction as well as functional improvement through central control with simultaneous use of different units for acceleration and braking have not yet been investigated.

Furthermore, the application effort of a brake is currently characterized by very extensive application work; in the case of braking systems according to the prior art (EP 2 536 607 B1, EP 3 036 136 B1) with ABS control with system pressure control via a plunger and pressure build-up via inlet valves and pressure reduction with time control via outlet valves, complex pressure models are required that must be adapted to each vehicle. It therefore takes numerous application engineers several years for an application for all driving situations and friction coefficient conditions.

It is the object of the invention to provide a driving dynamics system (DDS) with a central domain control via a driving dynamics domain or a central processor as well as with wheel modules or vehicle axle modules with multiple brake units (electric traction motor, electrohydraulic pressure actuators (EHB), and/or electromechanical brake actuators (EMB)) whereby the synergies between the individual brake modules are maximally exploited for the implementation of a braking task. The aim is to minimize the overall costs, weight, and thermal load on the components of the braking system. At the same time, the braking distance should be minimized, and driving stability should be ensured.

The wheel or axle modules should be preferably controlled in such a way that the respective wheel or vehicle axle only implements the target braking torques, and the distribution of the braking torques to the wheels or axles is calculated in a central processor, where the core functions of the anti-lock braking system ABS, anti-skid control ASC, electronic stability control ESP/ESC, electric brakeforce distribution EBD, and recuperative braking management are also implemented. The purpose of the control electronics of the wheel or axle module is to distribute the target braking torques to the various brake units of the wheels or vehicle axle.

Furthermore, a method for controlling a vehicle in highly dynamic braking mode (emergency braking function, AEB, and in particular subsequent ABS control mode) is to be provided for a vehicle with a corresponding driving dynamics system (DDS) which is optimized for braking distance and by means of which the controllability in critical driving situations (ABS mode on snow or ice) is optimized. In addition, the brake modules are to be designed in such a way that rapid application is possible and, in particular, that the application can be automated.

Furthermore, the brake modules are to be advantageously designed in such a way that an interruption in control mode is either avoided or prevented by additional hydraulic volume, as taught by EP 2 580 095 B1 and implemented in two integrated braking systems on the market (DE 10 2018 212 905 A1, DE 10 2019 204 016 A1), or by dead times in a multiplex control process, or is compensated for by control interventions via electric traction motors.

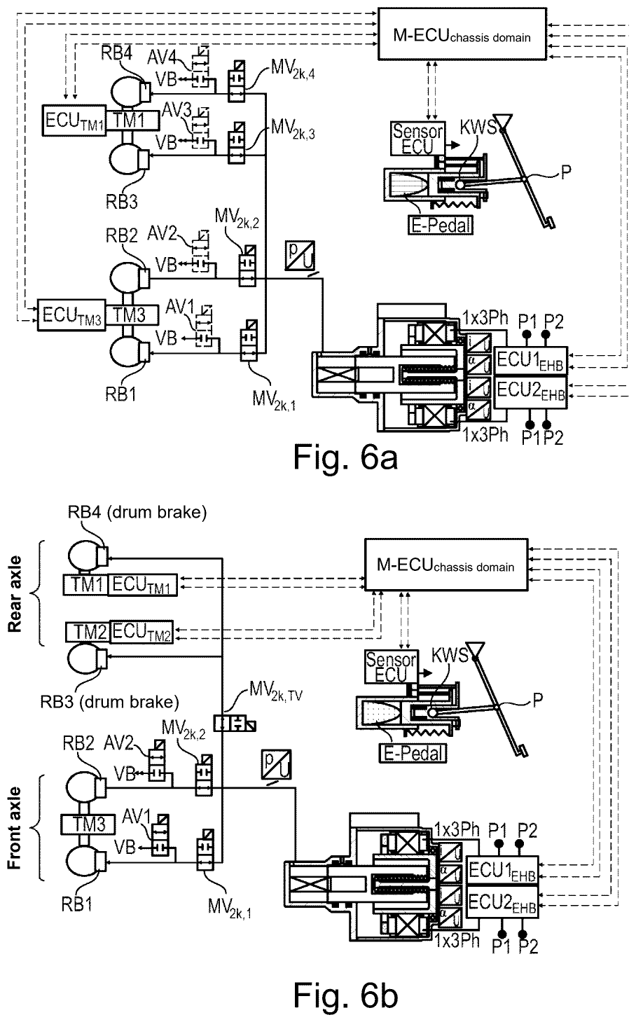

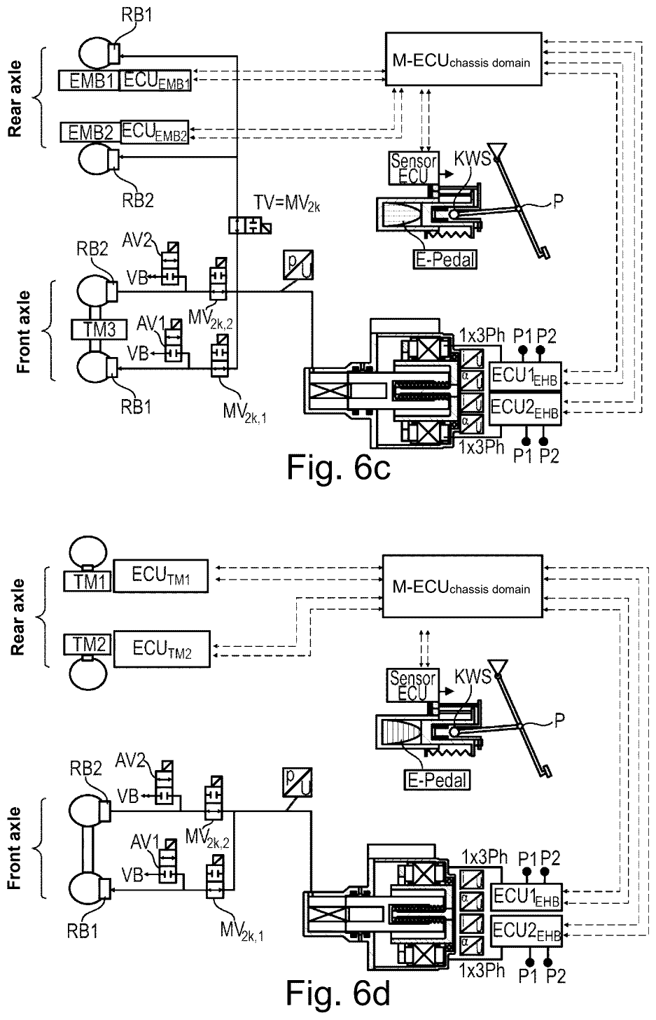

Furthermore, the brake modules are to be advantageously designed in such a way that a diagnosable valve device is provided between the pressure supply unit and the hydraulic consumer, in particular a wheel brake or multiple wheel brakes of an axle, in particular a normally open wheel valve (referred to as MV_{2k,1}, MK_{2k,2}, MV_{2k,3}, MV_{2k,4} in the following FIG. 6a) and/or a circuit shut-off valve (referred to as MV₂ₖ, TV in the following FIG. 6b), which is designed for a bidirectional volume flow, i.e., both during pressure build-up and pressure reduction, which makes it possible to isolate the corresponding consumer through closure of the valve device in the event of a leak in a consumer and to continue operating the system with one less consumer.

In the prior art (EP 3 036 136 B1), a check valve (referred to as inlet valve 88 and check valve 92 in EP 3 036 136 B1, FIG. 1) is provided in parallel to the wheel inlet valve, for example, which is necessary in order to be able to safely reduce the pressure in the wheel brake in any situation, in particular in the event of a failure of the ECU or power supply.

The novel design with a normally open valve device has the decisive advantage that the failure of a wheel circuit can be clearly diagnosed because there is no uncertainty as to whether the leakage is caused by the switching valve or by the check valve. If the leakage of the valve or the failure of the hydraulic line to the wheel brake or multiple wheel brakes is diagnosed, for example by means of a method as described in WO 2018/011021 A1, the hydraulic circuit can be safely disconnected through closure of the valve and the braking system can continue to operate with only one less consumer. This has a decisive advantage over braking systems with typically two brake circuits and four wheel brakes (known in the prior art as a black-and-white brake circuit (II) or diagonal brake circuit (X)), in which two wheel brakes must be deactivated directly in the event of a fault. The advantage of the novel valve device is substantial: In the event of a fault, the achievable deceleration is substantially greater with three instead of two wheel circuits, and it is also possible for yaw moment interventions for ESP and steering interventions to be maintained with three wheel circuits without major performance losses. If an electric drive motor is also available to drive and brake the failed wheel and this is integrated into the control system, even a braking torque control with four wheel brakes can still be implemented in the event of a fault.

Furthermore, the braking system is to be designed in such a way that, particularly by virtue of the high computing power of the central or domain processor, a simple application of the core functions via the central control system is possible in the automated application of the functions in development and, in particular, also in vehicle operation via learning algorithms or artificial intelligence (AI), both before the vehicle is put into operation for the first time and subsequently during normal operation without faults as well as adapted operation when a fault occurs.

With the AI approach, a powerful central processor with sufficient performance can take over the task of the application engineer, which is not possible with microcontrollers of the prior art as they are employed in known control units of braking systems due to their very limited performance and limited memory. The central processor acquires measurement data during vehicle operation, evaluates it, and applies various functions, in particular the safety-critical functions ABS, ESP, and AEB, during vehicle operation or when the vehicle is at a standstill, when the vehicle is not moving and the adjustment is therefore not time-critical.

Therefore, the adjustment takes place particularly after vehicle operation when the vehicle is parked. As a closed hydraulic system, in particular with pressure build-up and pressure reduction via bidirectionally acting valves by means of a pressure supply unit, the preferred design has the great advantage that the nonlinear relationships can be mapped by suitable sensors via characteristic maps (e.g., pressure-volume characteristic curve, relationship between motor current and braking pressure, relationship between braking pressure, and/or deceleration when the wheel brake heats up). Furthermore, these maps can be adapted during operation by detecting environmental influences, for example air in the system or heating of the wheel brake.

If the nonlinear relationships are mapped in mathematical functions or characteristic maps, an automatic application of an electrohydraulic braking system can also be carried out.

If the AI approach is consistently implemented in a hydraulic braking system (EHB), the advantage of the easily adjustable or controllable electromechanical brake (EMB) disappears, and the advantages of the lower manufacturing costs of the hydraulic braking system take effect, since the disadvantages in the application costs largely disappear.

Furthermore, different approaches to a solution are to be investigated as a function of the electric drive architecture and the level of automated driving. Therefore, solutions are presented for the following different architectures of electric traction motor arrangement shown in FIG. 1b:
a) an electric traction motor TM1, TM2 on rear axle HA or front axle VA;
b) an electric traction motor TM1 on the rear axle HA and an electric traction motor TM3 on the front axle VA;
c) two electric traction motors TM1, TM2 on rear axle HA for wheel-specific torque control of both wheels R1, R2; and
d) two electric traction motors TM1, TM2 on the rear axle HA and one electric traction motor TM3 on the front axle VA.

Variants a) to d) can be combined as desired, with emphasis being placed in the further embodiments according to the invention on the most effective solutions, b) and c).

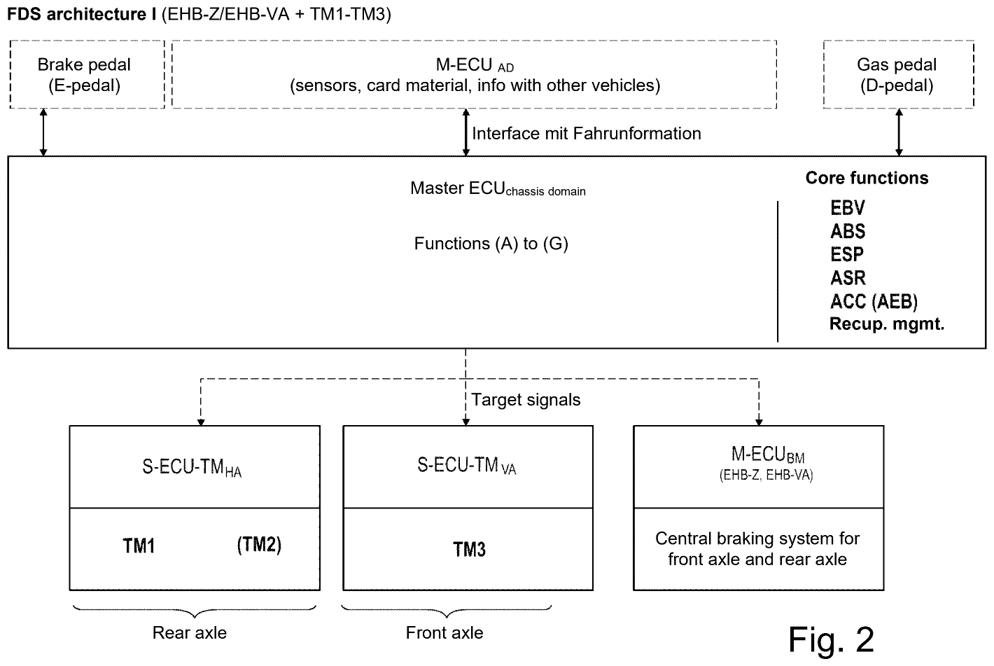

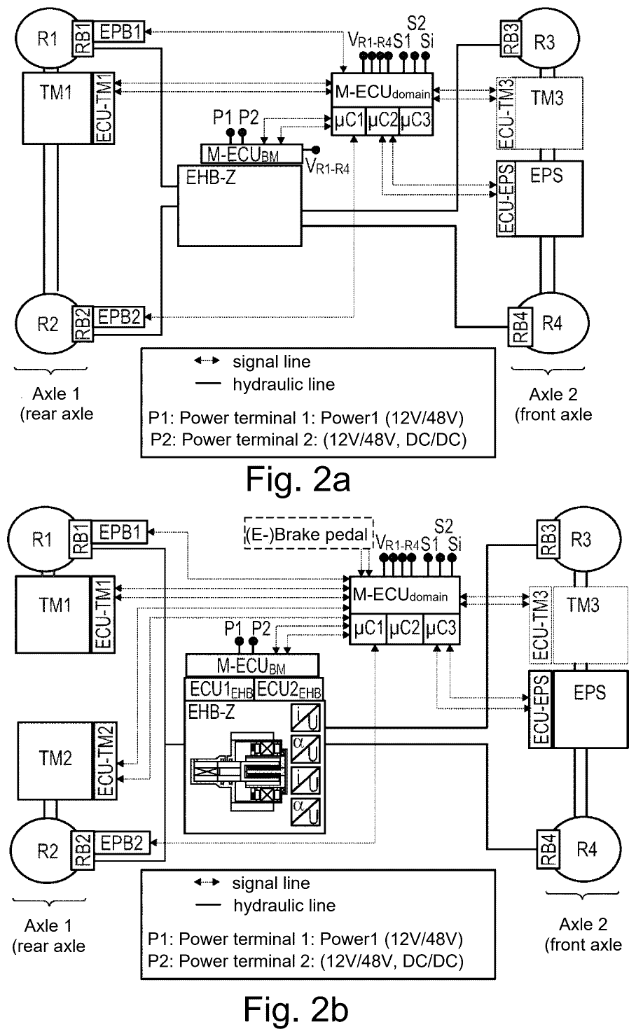

In addition to the electric drive modules, the following brake unit configurations are to be investigated, which are shown in FIG. 2c:
a) central electrohydraulic brake (EHB-Z) with wheel-specific braking torque control options for four wheel brakes (R1, R2, R3, R4) via solenoid valves;
b) axle modules with electrohydraulic brake (EHB-VA) with wheel-specific braking torque control options for two wheels (R1, R2) of a front axle (VA), optionally combined with one hydraulic line for two wheel brakes (R3, R4) of a rear axle (HA) (for example, see FIGS. 6b and 6c explained in greater detail below);
c) axle modules with electrohydraulic brake (EHB1, EHB2) for two wheels (R1, R2; R3, R4) of an axle (VA, HA) with wheel-specific braking torque control via solenoid valves; and
d) wheel modules with electromechanical brake (EMB1-EMB4) for each wheel (R1, R2, R3, R4) of a vehicle.

Moreover, different requirements of SAE Levels 2-5 of automated driving are be taken into account in the design of the embodiments. The approaches to a solution differ depending on whether only a fail-safe solution is required for SAE Level 2 or a fail-operational solution is required for SAE Level 3-5.
To begin with, the following priorities apply to a braking system:

| | |
|---|---|
| Priority 1 | Vehicle deceleration: In each failure mode, an appropriate |
| | deceleration must be achieved. Basically: The higher the |
| | maneuvering speed of the autonomous vehicle, the greater |
| | the deceleration should be in fault mode. |
| Priority 2 | Vehicle stability: When braking in the first failure mode, |
| | locking of the rear wheels must be avoided. |
| Priority 3 | Vehicle controllability: When braking in one of the first |
| | failure modes, locking of the front wheels must be avoided. |
| Priority 4 | With a fixed setting (without EBD function) according to the |
| | ECE 13 directive, the brakeforce distribution must be |
| | selected such that the front axle locks before the rear axle |
| | up to 0.85 g. |
| | If the EBD function fails, a vehicle deceleration of up to 5.8 |
| | m/s² must be achievable without locking, otherwise the |
| | warning lamp will light up, signaling a failure of the EBD |
| | function. |

The following main requirements are defined based on the priorities explained above, the time delays in driver intervention, the duration and speed of autonomous driving (SAE Level 3-4), and the assumption of liability by the automobile manufacturers.

| | Basic brake | Control function(s) |
|---|---|---|
| SAE | Braking according to ECE- | No redundant ABS/ESP required |
| Level | 13-H (0.244 m/s² (EU)), | |
| 2 | 0.3 m/s² in China, by | |
| | driver via brake pedal | |
| | Braking 0.51 m/s² via brake | |
| | pedal with 500N in case of | |
| | failure of the pressure | |
| | supply (typical design 1-box | |
| | braking systems with 19 | |
| | mm² master brake cylinders | |
| SAE | Redundant basic brake, | Driving stability function up to |
| Level | safe braking up to 0.58 | 0.58 m/s2 ABS stutter brake (e.g., |
| 2+ | m/s² by driver via brake | with iBooster) if the EBD function |
| | pedal | fails |
| SAE | Redundant basic brake up | Driving stability up to 1 m/s² with |
| Level | to 1 g deceleration, | compromises in braking distance |
| 3 | Red. AEB function with | Redundant EBD function |
| | degradation in dynamics | Redundant ABS function with |
| | (500 ms) | degradation (2-channel ABS on |
| | | front axle and rear axle or 2- |
| | | channel on wheels of the front |
| | | axle) |
| | | Partially redundant steering |
| SAE | Redundant basic brake up | Driving stability up to 1 m/s² |
| Level | to 1 g, | without compromising on braking |
| 4 | AEB function with full | distance |
| | dynamics (150 ms) | Redundant EBD function |
| | | Redundant ABS function (3-4 |
| | | channels) |
| | | Redundant ESP function |
| | | Fully redundant steering |

| | |
|---|---|
| SAE | 2-out-of-3 principle |
| Level | Preferably 3-fold redundancy with degradation at the 3rd |
| 5 | redundancy level (e.g., steering interventions via EHB or braking |
| | interventions via electric traction motors) |

The object of the invention is achieved by a driving dynamics system DDS, by a vehicle with the driving dynamics system, and by a method for operating the driving dynamics system according to the independent claims. Advantageous embodiments and refinements of the invention are specified in the subclaims.

The driving dynamics system for a vehicle comprises, in particular, at least one wheel brake for dissipatively braking a wheel of the vehicle and at least one brake unit which is associated with the at least one wheel brake and is designed to generate a dissipative braking torque by means of the at least one wheel brake. It further comprises at least one electric traction motor which can be controlled to generate a regenerative braking torque for at least one wheel or axle of the vehicle. It also comprises a central control unit which is designed to control a braking function of the at least one brake unit and the at least one electric traction motor in combination with one another such that a combined braking torque can be generated by means of the at least one brake unit and the at least one electric motor. The braking function relates to a control case in which a basic braking torque and a controlled additional braking torque are controlled and/or regulated simultaneously. In this case, the basic braking torque is optionally generated by the at least one brake unit, and the controlled additional braking torque is generated by the at least one electric traction motor; or the basic braking torque is generated by the at least one electric traction motor and the controlled additional braking torque is generated by the at least one brake unit; or the at least one brake unit and the at least one electric traction motor each jointly generate the basic braking torque and the controlled additional braking torque.

In one embodiment of the invention, at least one, preferably a plurality, of the following functions is selected as the braking function:
automatic emergency brake (AEB), in particular with an EBD control, in particular with an EBD control on a rear axle and a front axle of the vehicle, a total braking torque being distributed between the rear axle and the front axle;
anti-lock braking system (ABS), in particular with basic braking torque assistance via at least one traction motor (TM1, TM2, TM3, TM4);
electronic stability program (ESP);
electronic brakeforce distribution (EBD);
anti-skid control (ASC);
distance control (Automated Cruise Control, ACC);
recuperation management, particularly for axle- or wheel-specific recuperation;
basic brake with thermal management;
yaw moment control in case of wheel brake failure; and/or
yaw moment intervention control for steering assistance.

In particular, the central control unit has a central computer, wherein the central computer preferably has redundant microcontrollers μC1, μC2, μC3 and/or a large memory, in particular on the order of gigabytes.

In one refinement of the driving dynamics system, the brake unit comprises an electric motor drive and is embodied as an electrohydraulic brake unit or as an electromechanical brake unit.

In one refinement, the brake unit is embodied as an electrohydraulic brake unit with an electric motor-operated pressure supply unit, a valve device being provided between the pressure supply unit and at least one wheel brake or multiple wheel brakes of an axle, the valve device comprising a normally open wheel valve and/or a circuit shut-off valve, and in the event of a leak in at least one wheel brake, the valve device is designed to isolate the wheel brake in question through closure of the valve device, and the central control unit is designed to control the at least one brake unit and/or the at least one electric traction motor in such a way that braking torque is controlled on the other wheels of the vehicle, particularly on at least three wheels. In particular, the wheel brakes of one axle of the vehicle, in particular the wheel brakes of the front axle, can be separated by means of the valve device.

In one refinement, the central control unit is coupled to at least one brake unit control unit of the brake unit.

In another embodiment, the central control unit is designed to transmit target signals to a motor control unit of the at least one traction motor and to a brake unit control unit of the at least one brake unit in the braking function.

In one embodiment, the central control unit is further configured to control the at least one electric traction motor for regenerative braking of the vehicle when the vehicle is traveling at a speed of more than 80 km/h for braking in normal operation, an electronic brakeforce distribution (EBD function) being simultaneously implemented on a front axle and a rear axle of the vehicle during regenerative braking. In particular, 20-40% of the total braking torque acts on the rear axle and 60-80% of the total torque acts on the front axle of the vehicle.

In one refinement, the wheel brake of one wheel of the vehicle is associated with its own brake unit, the brake unit particularly having an electromechanical design. In particular, for each of the two wheels, the brake unit associated with the wheel brake and an electric traction motor are integrated into a wheel module.

In one design, the wheel brakes of two wheels on one axle of the vehicle are associated with a common brake unit. In particular, the brake unit has an electrohydraulic design, with a first brake unit being associated with the two wheels of a rear axle and a second brake unit being associated with the two wheels of a front axle.

A central brake unit is associated with the wheel brakes of four wheels of the vehicle, the central brake unit in particular having an electrohydraulic design.

In one embodiment, a common brake unit is associated with the wheel brakes of two wheels of a first axle, in particular a front axle, of the vehicle. The brake unit in particular has an electrohydraulic design. In particular, wheel-specific dissipative braking torques can be adjusted for the wheel brakes of the first axle, in particular by means of solenoid valves in hydraulic lines between the brake unit and the wheel brakes. In particular, the brake unit can also be connected via a hydraulic line to the wheel brakes of two wheels of a second axle, in particular a rear axle. In particular, common, non-wheel-specific dissipative braking torques can be set for the wheel brakes of the second axle.

In one embodiment, a first electric traction motor is associated with a first pair of two wheels of a first axle, in particular a rear axle of the vehicle, and a second electric traction motor is associated with a second pair of wheels of a second axle, in particular a front axle of the vehicle.

In one embodiment, a first and a second wheel of a first axle, in particular a rear axle of the vehicle, are each associated with their own electric traction motor.

In one refinement, the first and the second wheel are each associated with their own brake unit, the respective brake units in particular having an electromechanical design. In particular, for the first and second wheels, the respective associated electric traction motor and the respective associated brake unit are integrated into a wheel module which is respectively associated with the first or second wheel.

In another embodiment, a third electric traction motor is jointly associated with a third and a fourth wheel of a second axle, in particular a front axle of the vehicle. In particular, a common brake unit is associated with the third and fourth wheels. In particular, the common brake unit has an electrohydraulic design. In particular, the third electric traction motor and the common brake unit are integrated into an axle module associated with the second axle; or in particular a central brake module is provided which in particular has an electrohydraulic design, wherein wheel-specific braking torques can be generated for the first and second wheels by means of the central brake module and a common braking torque can be generated for the third and fourth wheels.

In one embodiment, the central control unit is configured to distribute the basic braking torque and the controlled additional braking torque to the at least one brake unit and the at least one electric traction motor as a function of the vehicle deceleration and/or as a function of a coefficient of friction of the roadway. In particular, in the case of a lesser deceleration and/or a lesser coefficient of friction, for example in the case of ABS control on snow or ice or in the case of a deceleration in ABS braking mode, an electromotive brake unit and/or the at least one electric traction motor generates the controlled additional braking torque. In particular, in the case of greater deceleration and/or a greater coefficient of friction, for example when braking on asphalt, an electrohydraulic brake unit generates the controlled additional braking torque. In particular, at medium deceleration and/or medium coefficient of friction, the brake unit or the traction motor generates the basic braking torque as a constant braking torque and an additional brake unit or the traction motor generates the controlled additional braking torque.

In one refinement, the central control unit is designed to carry out an EBD control in the event of an automatic emergency braking, the braking torque gradients of the at least one brake unit and the at least one electric traction motor being taken into account such that the maximum braking torque, in particular the maximum braking torque before the wheels lock, is achieved simultaneously on the front axle and on the rear axle of the vehicle.

In one refinement, at least one of the following strategies is used during regenerative braking, particularly when a vehicle battery is fully charged:
feeding the regenerated energy back into the battery up to the limit of power consumption;
field-oriented control (Id/Iq current control) of the electric traction motor in such a way that the energy in the motor is dissipated internally;
dissipating the energy generated by the electric traction motor in generative mode, making the energy generated available for an electrical consumer of the vehicle, and/or heating a fluid reservoir for use with a heat pump for cooling or heating; and/or
use of a temporary buffer store, preferably electrical, designed for pulse power, for example a super-cap or a flywheel energy storage device.

In one refinement, the at least one electric traction motor is operated with an inverter for switching windings of the at least one electric traction motor in series connection or parallel connection of three strings each of the excitation coils of the brushless electric motor. In particular, the inverter makes 4-quadrant operation possible, namely with a quadrant 1 with positive speed and positive torque of the electric motor; a quadrant 2 with positive speed and negative torque of the electric motor; a quadrant 3 with negative speed and positive torque of the electric motor; and a quadrant 4 with negative speed and negative torque of the electric motor.

In one embodiment, the central control unit is designed to carry out the brake control on the basis of a characteristic map, the characteristic map in particular depicting a pressure-volume characteristic, a relationship between motor current and braking pressure, and/or a relationship between braking pressure and/or deceleration when the wheel brake heats up.

In another embodiment, the central control unit is designed to acquire sensor data during vehicle operation, in particular in a state after the vehicle has been put into operation for the first time, for example during driving or when stationary before or after driving, and to adapt the control of the braking function on the basis of the acquired sensor data by means of an artificial intelligence method, in particular machine learning or neural networks. In particular, the artificial intelligence process can be carried out by means of a processor in the central control unit. In particular, the adjustment is carried out when the vehicle is in a safe state, in particular when the vehicle is parked. A characteristic map is determined particularly on the basis of the acquired sensor data, which, for example, maps a pressure-volume characteristic curve, a relationship between motor current and braking pressure, and/or a relationship between braking pressure and/or deceleration when the wheel brake heats up. In particular, the characteristic map can be adapted based on the sensor data and the artificial intelligence process if a deviation from the current characteristic map is detected, for example due to environmental influences, air in the system, or heating of the wheel brake.

Another driving dynamics system for a vehicle comprises at least one electric traction motor which can be controlled to generate a regenerative braking torque for at least one wheel or axle of the vehicle, and a central control unit which is configured to control the at least one electric traction motor for a braking function. The central control unit is designed to carry out the braking function when braking on a roadway with a low coefficient of friction, in particular on snow, ice, and/or wet roads, with low to moderate decelerations, in particular of less than 0.5 m/s². In particular, the central control unit is designed to carry out the braking function by means of at least one traction motor of at least one axle of the vehicle, in particular by means of two traction motors of the rear axle of the vehicle.

The vehicle according to the invention comprises a driving dynamics system according to the present description or according to the appended claims.

In the method for operating a driving dynamics system with at least one brake unit for generating a dissipative braking torque and at least one electric traction motor for generating a regenerative braking torque for at least one wheel or axle of the vehicle, and a central control unit for controlling the at least one brake unit and the at least one electric traction motor for a braking function, a combined braking torque is generated by means of the at least one brake unit and the at least one electric traction motor. The braking function relates to a control case in which a basic braking torque and a controlled additional braking torque are controlled and/or regulated simultaneously. In this case, the at least one brake unit is optionally controlled to generate a basic braking torque, and the at least one electric traction motor is controlled to generate the controlled additional braking torque; or the at least one electric traction motor is controlled to generate the basic braking torque and the at least one brake unit is controlled to generate the controlled additional braking torque; or the at least one brake unit and the at least one electric traction motor are controlled to jointly generate the basic braking torque and the controlled additional braking torque.

The at least one electric traction motor for driving and braking an axle or a wheel of the vehicle has in particular a slave control unit on one or more axles or wheels of a vehicle.

The at least one brake unit or braking system is designed in particular for multiple wheel brakes, multiple electrohydraulic brake modules, or multiple electromechanical brake modules.

For example, a central vehicle model can be provided for the control system by means of which the braking requirements for the wheel modules or axle modules can be calculated in consideration of the coefficient of friction of the roadway, vehicle speed, and weight distribution during braking.

Furthermore, brake control models and characteristic maps for synchronized brake torque control for the at least one traction motor and the brake unit, in particular EHB or EMB, can be provided in the sense that either the at least one electric traction motor or the brake unit, in particular EHB or EMB, provides a basic brake torque, while the dynamic brake torque control is carried out jointly by the at least one electric traction motor and the brake unit, in particular EHB or EMB, in particular by a controlled additional brake torque generated thereby.

Furthermore, sensor data from sensors can be used, the sensor data being important for the implemented core functions and being read into the central control unit. For example, the sensor data from wheel speed sensors for an ABS function, yaw moment sensors for an ESP function, acceleration sensors and/or weight sensors for an EBD function, and comparison of the functional relationship between braking pressure/brake torque and deceleration of the vehicle, which depends in particular on the temperature of the brake disc(s), and/or sensors for electrical recuperation strategies or emergency braking functions (AEB) can be provided.

The central driving dynamics system can, for example, be used in such a way that the use of at least one brake unit is optimized with a view to maximizing recuperation as well as braking or braking control performance in different driving situations. This is done in particular as a function of a braking situation, such as comfort braking or emergency braking, as well as a road situation, such as braking on asphalt, on snow, or on ice, in a so-called u-jump or u-split, and the availability of the brake units. In particular, the costs of the brake calipers can be reduced through intelligent control via the driving dynamics system, in particular by minimizing the thermal load on the friction brake and reducing the size and/or selecting the appropriate type of friction brake used, for example a drum brake or a disc brake.

In a first “Architecture I,” a hydraulic braking system for wheels on the front axle and the rear axle (EHB-Z) or a hydraulic braking system for the front axle only (EHB-VA) can be controlled together with at least one electric traction motor via the central control unit as a brake unit. In Architecture I, a control unit (M-ECU_{BM}, S-ECU_{TM,HA}, S-ECU_{TM,VA}) having an interface to the central control unit is provided for the brake unit EHB-Z or EHB-VA and the at least one electric traction motor of the respective axle. The central control unit M-ECU_{domain} synchronizes the target signals to the abovementioned control units (M-ECU_{BM}, S-ECU_{TM,HA}, S-ECU_{TM,VA}), the target signals in particular being or including target braking torques.

With this architecture, a great potential for an SAE Level 2 braking system with fail-safe operation can be exploited without changing the installed braking system. Such a braking system can, for example, be a common commercially available 1-box braking system as described in DE102018212905A1, DE102019204016A1, or DE102019122169A1. This does not require any change to the mechanical or hydraulic construction of the braking system, but merely an extension via an interface, such as a wheel-specific target pressure interface or a wheel-specific target torque interface. This is achieved by integration into the central control unit (domain) and intelligent control of the brake unit and the installed electric traction motors on one or both vehicle axles or two wheels of a vehicle axle.

As an alternative to the conventional braking systems mentioned above, the brake unit (EHB) is advantageously further optimized such that the brake unit (EHB) is only embodied as a wheel-specific pressure actuator with wheel control valves. Each of the hydraulically actuated wheel brakes forms a separate wheel circuit and can be preferably separated through closure of the preferably normally open wheel valves MV₂ₖ. Furthermore, an EHB pressure actuator with control valves for the front axle only (EHB-1, EHB-VA) and/or a pressure actuator with control valves for the rear axle (EHB-2) and/or a pressure actuator (EHB-Z) can be provided as the brake unit, additionally with a brake circuit for both wheels of the rear axle. The abovementioned solutions EHB-1 and EHB-2 use “Architecture II,” which will be explained in later sections and figures.

In a version for SAE Level 4, the driver's request is no longer acquired conventionally with an actuation unit for detecting the driver's request, but with a piston-cylinder unit with preferably a piston and a hydraulic pressure chamber as well as a hydraulic connection to the brake circuits or via an e-pedal. The driver input signals are read redundantly into the M-ECU_{domain}. For SAE Level 5, a pedal is no longer required. The modular design with e-pedal has the decisive advantage over the prior art that SAE Level 4 and SAE Level 5 can be covered modularly, and the elimination of the hydraulic connection between the actuation unit and a pressure actuator makes an especially high degree of flexibility possible in accommodating the pressure actuator in the vehicle. What is more, noise sources are avoided, because the hydraulic pressure modulation noises are generated away from the bulkhead and there is therefore no structure-borne noise transmission to the passenger compartment. Such embodiments of an electrohydraulic braking system are described in greater detail in FIGS. 6a to 6d.

The different embodiments of the brake unit (EHB) and Architectures I to II explained above are thus made possible by a central vehicle model by means of which functions (a) to (g) are implemented.

In a first advantageous function (a) basic braking function, the heating of the friction brake is minimized by predominantly using at least one electric motor for braking. If a braking system is designed with a blending strategy according to the prior art (see FIG. 1b), the maximum pressure in the AMS fading test is used as the basis for dimensioning (see Bremsenhandbuch [Brake Manual], 5th edition, chapter 6.3.2, FIG. 6.10). That is, 10 subsequent braking maneuvers from 100 km/h are simulated for the AMS test. Accordingly, the wheel brakes on the front axle heat up to 600° C. and the wheel brakes on the rear axle to around 500° C. The pedal force on standard vacuum brake boosters then increases by around 80%, which means that the braking system must be designed for a pressure 80% higher than the normal locking pressure in the event of fading. With an appropriate safety reserve, braking systems are therefore typically designed for a maximum pressure of around 200 to 220 bar. Typical blending strategies do not provide for regenerative braking at higher speeds above 60 km/h (Bremsenhandbuch [Brake Manual], 5th edition, chapter 19.3.2, FIG. 19.12); the potential of the braking power of electric motors is therefore not exploited. This limitation of regenerative braking to speed ranges below 60 km/h is due, on the one hand, to limits on the volume absorption during blending, such as the volume absorption by a reservoir of the ESP unit in a 2-box braking system with electric brake boosters. On the other hand, liability on the part of the brake manufacturer and legislation speak against an expansion of regenerative braking operation. Furthermore, these limitations may be due to the fact that the battery's capacity to absorb energy is limited, particularly when fully charged.

With a central DDS control, the potential of regenerative braking is able to be fully exploited. Furthermore, the heating of the friction brake and thus also the fading effect can be substantially reduced because the braking energy no longer leads to significant heating of the friction brake. For example, the at least one electric traction motor can be operated with an inverter which enables 4-quadrant operation (quadrant 1: positive speed, positive torque; quadrant 2: positive motor speed, negative motor torque; quadrant 3: negative motor speed, positive motor torque; quadrant 4: negative motor speed, negative motor torque). An electric traction motor with an exemplary drive power of 130 KW with a torque of 250 Nm on a rear axle of a mid-range vehicle (cf. BMW i3 vehicle with max. braking torque 2000 Nm on rear wheel/3000 Nm on front wheel) can then also be braked in the second quadrant with almost the same torque and the same power. The generative braking torque of the electric traction motors is slightly greater than the drive braking torque of the electric traction motor, since losses in the motor and transmission also have a braking effect, while the losses reduce the drive torque during acceleration. With such a design, at a speed of 100 km/h, approximately 60-70% of the braking energy on the rear axle can be retained through regenerative braking. If such a motor is also installed on the front axle, then a deceleration of about 50% can also be achieved on the front axle. When braking via electric traction motors, one or more energy management strategies are pursued and, through efficient selection or combination of strategies, braking via the electric traction motor is limited de facto only by the torque limits in the 4-quadrant operation of the inverter.

The following four basic energy management strategies are available:
(1) Recovery into battery up to the limit of power consumption: This depends, among other things, on the energy absorption capacity of the battery, in particular on the current state of charge (SOC) of the battery.
(2) Field-oriented control (Id/Iq current control) of the electric motor such that the energy in the electric traction motor is dissipated internally: The internal energy dissipation is limited by resistances of the excitation windings of the stator of the electric traction motor and eddy current losses as well as the possibilities for cooling the motor. Since electric traction motors are designed for water or oil cooling and the heating in the pulse load during the braking process, which is normally completed in 5-10 seconds during full braking, is dampened by the large thermal mass of the electric motor, the absorption of energy by the electric motor in pulse mode is rather uncritical and can therefore usually be fully exploited.

Furthermore, a cooling circuit of the electric traction motor can be routed into a water reservoir which, in turn, is exploited by means of a heat pump in order to achieve an especially efficient cooling and heating of the interior of the vehicle. This means that the energy that is “wasted” in the traction motor can be utilized, particularly with a heat pump efficiency of greater than 300%.
(3) As a third option, the energy generated by the electric traction motor in generative mode can be utilized via a wear-free eddy current brake, as known from motor dynamometers, or another medium (e.g., water) can be heated in a manner comparable to a kettle. The heat generated can also advantageously be employed via a heat exchanger in order to achieve an especially cooling or heating of the vehicle. Preferably, the energy of one or more electric traction motors is fed to a heat sink
(4) As a fourth option, an electrical temporary buffer store can be provided which is designed for pulse power, such as a super-cap or flywheel energy storage device. Super-capacitors or flywheel energy storage devices are especially well suited for pulse power and are capable of absorbing substantially more peak power than a battery. The energy temporarily stored in the super-cap or flywheel energy storage device can be used when accelerating the vehicle after braking or for other purposes in the vehicle.

By virtue of the recuperative braking management with energy management, the heating of the friction brake in the AMS test can be reduced by more than 50%, and in particular even by up to 70-80%. This effect can be used to advantage by simplifying the friction brake on the front axle and using a cost-effective, lightweight drum brake on the rear axle. Alternatively, the effect can be used to design the hydraulic brake for substantially lower maximum braking pressures, for example 120-140 bar instead of 200-220 bar, which has a beneficial effect on the costs of the braking system because the pressure supply can be equipped with a smaller electric motor. In addition, the hydraulic volume of the pressure supply unit can be reduced.

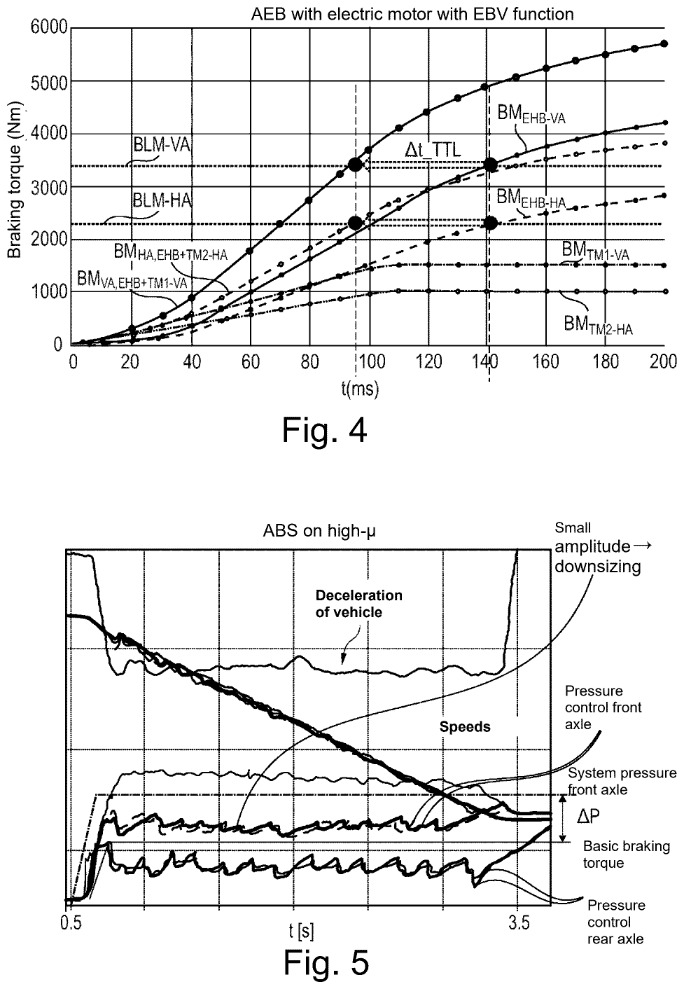

Moreover, by appropriately designing the interface between the driving dynamics system and the braking system with access to the control of the electronic brakeforce distribution (EBD function) in a second advantageous function (b), the dynamics of the automatic emergency braking (AEB) can be further enhanced, which has a substantial impact on the braking distance, especially at high vehicle speeds. If braking is performed via the electric motor, the driving dynamics system must ensure that driving stability (see above—Priority 2) and controllability (see table above—Priority 3) are maintained in order to meet legal requirements and ensure the safety of the vehicle. This means, for example, that the rear axle must not lock before the front axle and, if the wheels lock, particularly the front axle, the ABS must be activated. The interface between the driving dynamics system and the braking system must therefore be designed in such a way and, preferably, the EBD function must be controlled in such a way that the maximum braking torque (wheel-lock limit) on the front axle and rear axle is reached almost simultaneously. As will be explained below with reference to FIG. 4, the time from the start of braking to maximum deceleration (TTL time) can be reduced from 140 ms to 90 ms even with an electric traction motor with an average power of 130 KW on the front and rear axles of a mid-range vehicle. At speeds of over 100 km/h, this can lead to a reduction of several meters in the braking distance. If the TTL time reduction cannot be implemented, for example due to chassis limitations, the braking effect of the electric motor can alternatively be used to make the braking system smaller and more cost-effective. This means that the pressure supply of the brake unit can be driven by a motor with lower torque and/or by a less powerful motor, or possibly by a cost-effective brush motor.

In a third advantageous function (c), axle-wise recuperation can be achieved via electric motors. Here, too, access from the driving dynamics system to the solenoid valves of the brake unit (EHB) or a suitable interface to the brake unit (EHB) must be defined so that the ABS operating state intervenes in critical fault cases. In the case of interaction between the brake unit (EHB) and the electric traction motors controlled via the driving dynamics system, the pressure build-up and pressure reduction must be regulated accordingly via inlet valves or shut-off valves to the brake circuit of the front axle for the cover. This can be achieved during pressure build-up, for example, through PMW control of the intake valves or, alternatively, during pressure reduction by means of the MUX process via intake valves or shut-off valves or through pressure reduction using exhaust valves.

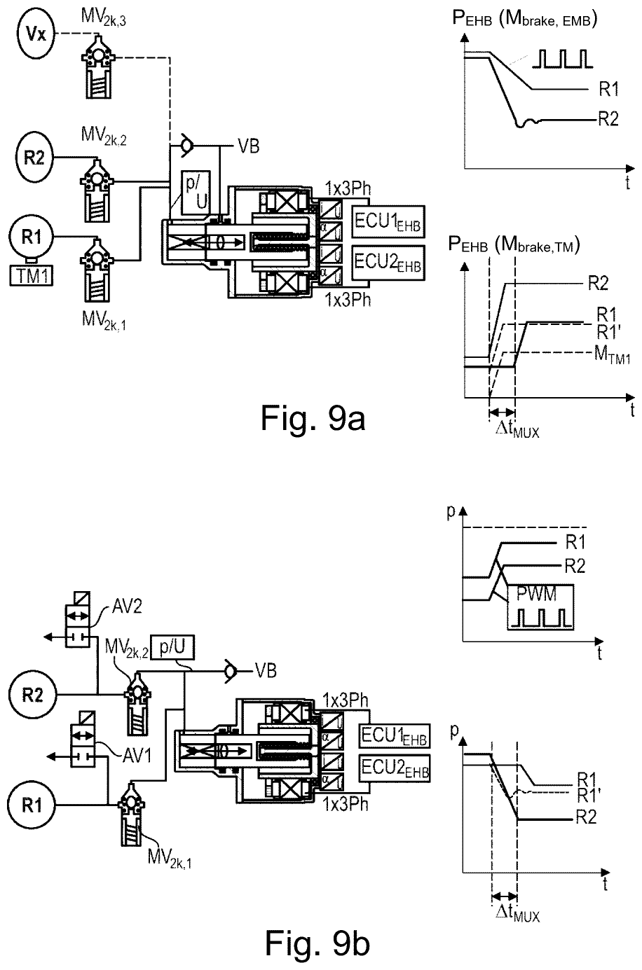

The solution in the EHB-Z and EHB-VA brake units, as described below with reference to FIGS. 6a-6d, is simpler and substantially more flexible, particularly when the wheel inlet valves are embodied as normally open solenoid valves MV₂ₖ (also referred to as inlet/outlet valves below) that are designed for bidirectional volume flow, so that the pressure can be maintained due to the lack of check valves when the pressure supply has a lower pressure level than the wheel brake and the hydraulic braking torque is to be kept constant in the recuperation strategy. While the pressure reduction takes place exclusively via the inlet/outlet valves in the embodiment of the EHB according to FIG. 9a or in the variants of FIGS. 6a-6d, in which no outlet valves are provided or only on some wheel brakes, in the embodiment according to FIGS. 6a to 6d and FIG. 9b, the degrees of freedom of the braking torque reduction exist through the inlet/outlet valves or through outlet valves. This is advantageous in the implementation of highly dynamic braking torque interventions. In the embodiment according to FIG. 6b, the axle-specific recuperation strategy is also not impacted much, since the pressure reduction takes place either via the inlet/outlet valves MV_{2k,1-4} or outlet valves AV₁-AV₄. In the recuperation strategy utilizing the driving dynamics system, the braking torque curve can be synchronized by the electric traction motor and the brake unit (EHB) in such a way that recuperation is maximized. If recuperation via the electric traction motor is limited—when the battery is fully charged, for example—the kinetic energy is dissipated via the brake unit (EHB); if the battery allows energy to be fed in, recuperation occurs primarily via the electric traction motor. With the wheel-specific degrees of freedom, axle-wise recuperation with an X-brakeforce distribution is therefore easy to implement.

In the design as an axle pressure actuator (EHB-1, EHB-2), preferably having a construction according to FIGS. 9a and 9b, the recuperation strategy is very simple and does not require valve confirmation, since the braking torque build-up and braking torque reduction can be carried out very precisely with the known PPC pressure regulation or pressure control.

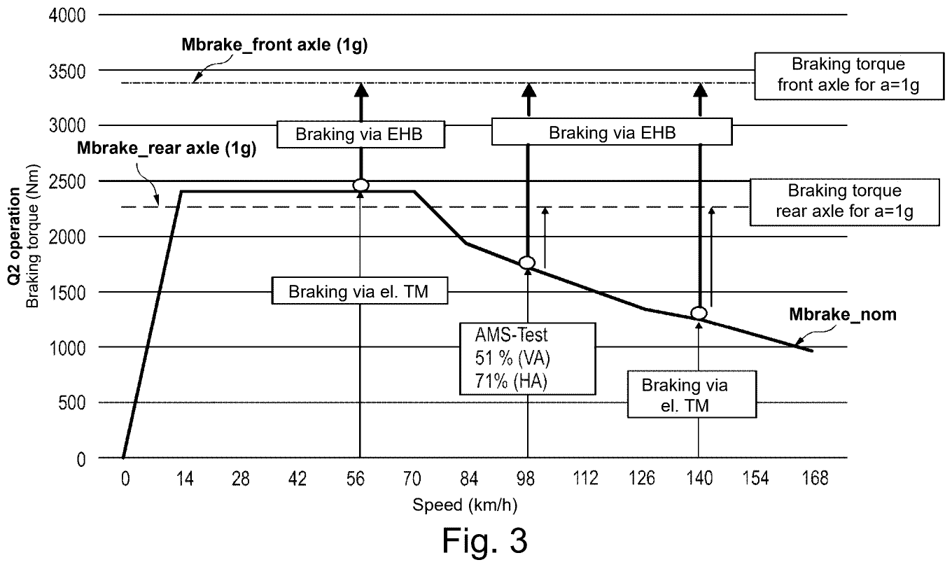

In a fourth advantageous function (d), the at least one electric traction motor can generate a basic braking torque in control mode. This is made possible by using modern electric traction motors with high power and torque (>200 Nm, <100 KW) and operating them with a high operating voltage (400 V, particularly 700-900 V). Such traction motors can perform braking torque changes with high dynamics (typical values: 15000 Nm/s, 30000 Nm/s are achievable), they can operate in 4 quadrant mode, and they are very dynamic in braking torque build-up and braking torque reduction. At low target braking torques, they are more dynamic than a hydraulic brake unit (EHB). Depending on the torque available over the entire speed range (1000 Nm in FIG. 3 up to the maximum vehicle speed), the maximum pressure of the brake unit (EHB) can be reduced by the maximum torque. Since a new type of ASC control is possible using electric traction motors (see ATZ 2/2014: “Regelalgorithmen für Rekuperation und Traktion bei Elektrofahrzeugen” [“Control algorithms for recuperation and traction in electric vehicles”]), high pressures are no longer required for ASC control compared to the prior art, so that the maximum pressure of the brake unit (EHB) is determined by normal braking operation.

In a fifth advantageous function (e), the at least one electric traction motor can be used to provide support in the event of a failure of the brake unit (EHB). Newer 1-box braking systems, such as those disclosed in DE102018212905A1, are designed in such a way that, if the pressure supply fails, only a deceleration of 0.3 m/s² is achieved via the driver's foot force, which meets the legal requirements of ECE-13-H with a minimum deceleration of 0.244 m/s² as well as regional requirements in China. If the brake unit (EHB) is integrated into the driving dynamics system, the braking force in the event of a fault can be reduced to 0.58 m/s² by using the braking force of electric drive motors, as is proposed in WO 2020/165255 A1. In addition, the electric drive motors, such as a TM1 motor on the rear axle and another TM3 motor on the front axle, can achieve a driving stability function that is comparable to that of a 2-box braking system (iBooster+ESP−hev). This means that SAE Level 2+ can be achieved by integrating the brake unit (EHB) into the central control of the driving dynamics system.

If the braking system presented in WO 2020/165255 A1 is refined in such a way that electric drive motors build up a basic braking torque according to function (d) and the pressure supply is also designed to be partially redundant with redundant windings, for example by being designed with 2×3 phases, (partially) redundant electronics (DV1-ECU1, DV-ECU2), and connections to two on-board networks and/or energy supplies (BN1, BN2) as well as data lines (DS1, DS2), the pressure supply can be operated at half power or half torque even if a winding or a power semiconductor of a motor output stage fails, which is the most common failure in EC motors. With a preferred design for 140-160 bar, a pressure of 70-80 bar can still be built up. This means that full ABS control is possible even in the event of a partial failure of the pressure supply. If, in addition, at least one traction motor is used in this fault case to set the basic braking torque for generating a basic braking torque, ABS mode with maximum deceleration, in particular approximately 1 to 1.4 g, can also be achieved.

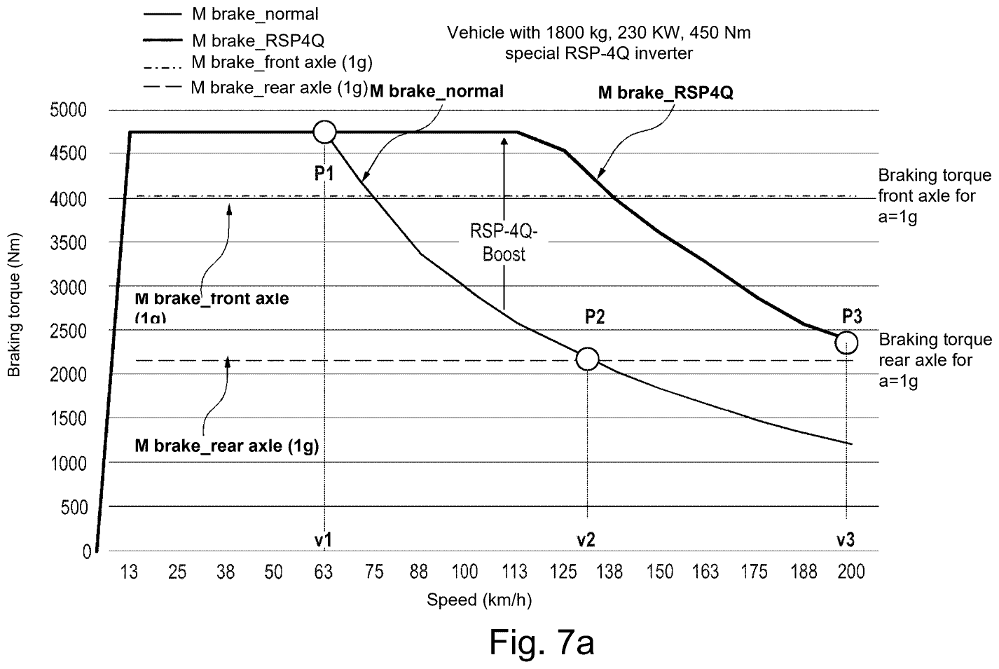

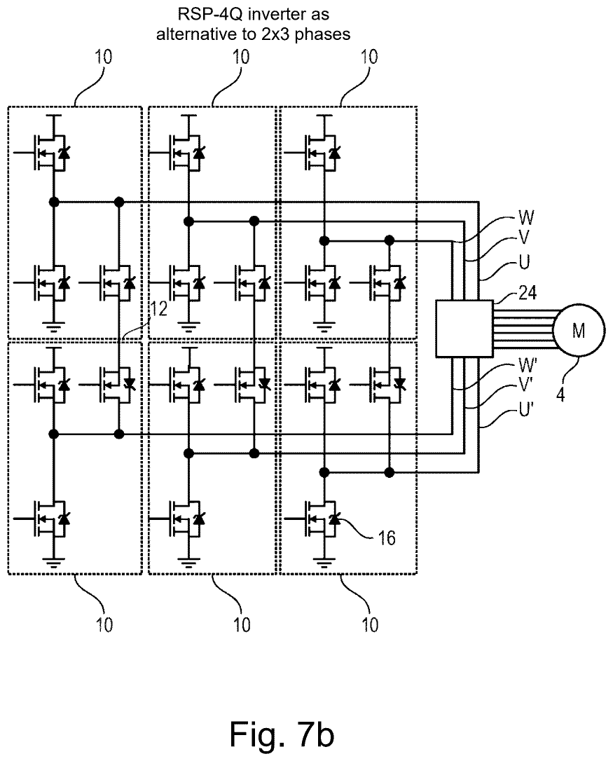

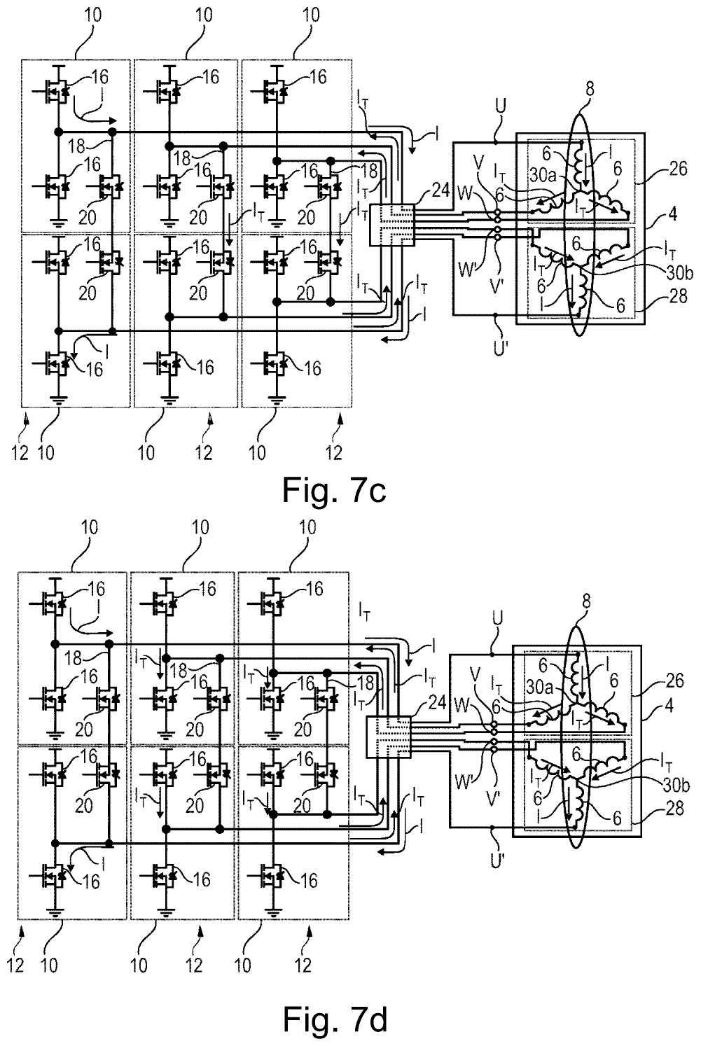

If, in a 1-box braking system, such as that according to WO 2020/165255 A1, inlet/outlet solenoid valves or switching solenoid valves (SV1-SV4 of FIG. 7 of WO 2020/165255 A1) designed for bidirectional volume flow are used between the pressure supply and the wheel brake in both brake fluid flow directions—i.e., from the pressure supply to the wheel brake and from the wheel brake to the pressure supply—each wheel circuit can be reliably diagnosed and isolated from the braking system in the event of a fault. This is not possible with the wheel inlet valves that are otherwise used in the prior art, since check valves that cannot be diagnosed and cannot be safely closed are used parallel to the inlet valves (for example, see reference numerals 6a-6d of FIG. 1 of DE 10 2013 222 281 A1). This means that the driving dynamics system can operate in 3-channel wheel pressure control mode even in the event of a fault, which makes a vehicle stabilization function possible, comparable to the ESP function, and enables pressure to be maintained in the wheel brake circuit. This, in turn, provides further degrees of freedom in braking torque control, particularly in the case of wheel-specific recuperation. This type of novel switch-on valve is preferably also used in the inventive EHB solutions of FIGS. 6a-6d and FIGS. 9a and 9b, which will be explained in greater detail below.

In any case, a 2-channel ABS function must be provided on the front axle to ensure controllability in accordance with Priority 3, which can be implemented even if no bidirectionally acting, normally open valve (switching solenoid valve MV₂ₖ) is provided on the wheel brakes. In this case, a shut-off valve is provided between the front axle and the rear axle. The pressure control can alternatively be carried out via the MUX pressure control method with pressure build-up and pressure reduction via switching valves, the switching valves being preferably designed in such a way that the valve seat of the solenoid valves is connected to the wheel brake in order to ensure that the braking pressure is not trapped in the wheel brake. Optionally, outlet valves can also be provided so that, as an alternative to MUX pressure reduction, the pressure reduction takes place via outlet valves into the reservoir. In this context, reference is also made to FIGS. 9a and 9b, which will be explained in greater detail below.

As a further alternative, the standard ABS control can be implemented, in which a system pressure is set via the pressure supply and the pressure build-up takes place via PWM control of the switching valves and pressure reduction via time control of the exhaust valves. Here the valve seat is connected to the pressure supply in order to enable proportional control of the flow cross section. Normally open switch valves are of special importance here in order to ensure that the braking pressure is not trapped in the wheel brake in the event of a fault at high differential pressures.

In a sixth advantageous function (f), yaw moment interventions for steering assistance can be carried out by means of a setpoint specification of the driving dynamics system. For this purpose, pressure build-up and pressure reduction can be regulated accordingly by means of inlet valves (for example, see reference numeral 11 of DE 10 2018 212 905 A1), so that the hydraulic braking force is modulated with the electrical braking force. This can be done during pressure build-up through PMW control of the inlet valves or, alternatively, during pressure reduction by means of the MUX process via inlet valves or shut-off valves or through pressure reduction via outlet valves.

The solution is simpler in the approach with EHB-Z and EHB-VA according to FIG. 6a and FIG. 9a, especially if the wheel inlet valves are embodied as normally open inlet/outlet valves that are designed for bidirectional volume flow, so that the pressure can be maintained due to the lack of check valves when the pressure supply has a lower pressure level than the wheel brake and the hydraulic braking torque is to be kept constant in the recuperation strategy. In addition, the degrees of freedom of braking torque reduction exist via the bidirectional inlet/outlet valves with simultaneous retraction of the piston of the piston-cylinder unit of the pressure supply device or via outlet valves into the reservoir, which is advantageous for the implementation of very dynamic braking torque interventions.

In a seventh advantageous function (g), wheel-specific braking torques for wheel-specific recuperation can be generated by means of a setpoint specification of the driving dynamics system. For this purpose, pressure build-up and pressure reduction must be regulated accordingly via inlet valves (see reference number 11 of DE 10 2018 212 905 A1), so that the hydraulic braking force is modulated with the electrical braking force. This can be done during pressure build-up through PMW control of the inlet valves or, alternatively, during pressure reduction by means of the MUX process via inlet valves or shut-off valves or through pressure reduction via outlet valves.

The solution with EHB-Z and EHB-VA according to FIGS. 6a, 6c and 9a-9b that is explained in greater detail below is simpler and substantially more flexible, especially if the wheel inlet valves are embodied as normally open inlet/outlet valves MV₂ₖ, so that the pressure can be maintained due to the lack of check valves when the pressure supply has a lower pressure level than the wheel brake and the hydraulic braking torque is to be kept constant in the recuperation strategy. While the pressure reduction takes place exclusively via the inlet/outlet valves in the embodiment of the brake unit (EHB) according to FIG. 9a or in the variants of FIGS. 6a-6d, in which no outlet valves are provided or only on some wheel brakes, in the embodiment according to FIGS. 6a to 6d and FIG. 9b, the degrees of freedom of the braking torque reduction exist through the inlet/outlet valves or through outlet valves. This is especially advantageous when implementing very flexible braking torque interventions in order to maximize recuperation. In the recuperation strategy utilizing the driving dynamics system, the braking torque curve of the at least one electric traction motor and brake unit (EHB) can be synchronized in such a way that recuperation is maximized. If recuperation via at least one electric traction motor is limited—when the battery is fully charged, for example—the kinetic energy is dissipated via the brake unit (EHB); if the battery allows energy to be fed in, recuperation occurs primarily via the electric traction motor.

For functions (e), (f), and (g), a normally open and cost-effective inlet/outlet valve MV₂ₖ is important because it can prevent a brake circuit failure and a wheel circuit can continue to operate even if the switching valves leak. In this way, a 4-channel wheel pressure controlled operation can be maintained even if the switching valves leak, or if a wheel circuit is switched off, emergency steering or steering assistance can still be carried out with the 3-channel wheel pressure controlled operation, which can simplify the redundancy requirements of the electric power steering for higher levels of automated driving (SAE Level 3-4). These functions (e) and (f) are of especially great importance for the overall costs of the primary chassis control actuators brake and steering. If an electric power steering system is designed to be completely redundant, two steering actuators are required. On the other hand, by virtue of function (f) as a redundancy function for the steering, the brake can represent a valid approach to fulfilling the SAE requirements of level 3-4; it also offers the advantage that a non-identical unit can be used for the redundant steering function, which means that production quality defects can be excluded as sources of error in identical steering units. The steering function via the brake unit (EHB) can also be provided as a third fallback level of an already redundant electric power steering system EPS with two steering actuators or as a second fallback level of an EPS that is not or only partially redundant, for example with a steering actuator with 2×3 phases and a redundant control unit. In addition, the steering unit (EHB) can support the steering on a second axle where no EPS is provided, or also perform yaw moment interventions in order to stabilize the vehicle in addition to steering interventions, for example when braking on a u-split.

With the functions explained above, the SAE requirements for Level 3 autonomous driving can also be met with a hydraulic braking system with only one pressure supply. All requirements for fulfilling SAE Levels 4 and 5 are also met with the inventive extension of a 1-box braking system according to FIGS. 6a and 6b. An emergency braking function with a standard dynamic response of 150 ms can also be ensured if the pressure supply is designed redundantly and, like in function (b), electric traction motors provide support in building up the braking torque. Although the maximum dynamic range of 90 ms of the inventive solution cannot normally be achieved, a TTL of 150-200 ms can be achieved with acceptable losses. This is commensurate with the performance data of commercially available brake boosters.

In comparison, braking systems for SAE Level 3 and 4 (see WO 2018233854 A1) can only rely on the pressure dynamics of the ESP pump in the event of a brake booster failure, which according to the current specifications only allows a pressure build-up of 450 ms to 50 bar. The driving dynamics system also offers the option of supporting the pressure build-up via the ESP pump with the braking torque build-up dynamics of an electric traction motor. Depending on the power of the electric traction motors, a TTL of approx. 150-250 ms can also be achieved for such a 2-box braking system with a weak ESP pump. In the event of a fault, the emergency braking function is then equivalent or almost equivalent to normal operation.

The integration of braking systems into a central control system, with the synergies and functional support explained above, ultimately offers the potential to dispense with the hydraulic fallback level via a brake pedal (see FIGS. 6-6c) and either introduce an e-pedal or dispense with the pedal completely. This means that a braking system with only one pressure supply in one unit (1-box braking system) with the DDS according to the invention certainly has the potential to achieve qualification for AD Level 5.

In a second “Architecture II,” axle modules are provided instead of a hydraulic braking system that is controlled centrally via the domain. For example, an axle module has at least two brake modules selected from among:
electric drive motor,
electromechanical brake (EMB) for each wheel,
electrohydraulic pressure actuator (EHB-VA, EHB-HA) for each axle with wheel control valves for braking torque control for both wheels of the axle.

For example, an axle module can comprise an electric drive motor by means of which the wheels of an axle (VA, HA) can be driven and braked generatively, as well as an electromechanical brake unit (EMB) for each of the two wheels of the axle or a common electrohydraulic brake unit (EHB-VA, EHB-HA) for both wheels of the axle (VA, HA).

In the second embodiment, in contrast to the first embodiment, a control unit (S-ECU_{VA}, S-ECU_{HA}) is provided for each axle which has a communication interface to the central control unit (M-ECU_{domain}) and controls the selected brake modules of the axle in a synchronized manner. Synchronization is advantageous particularly for controlled operation in contrast to normal operation of the brake, because different delay times and time curves in the braking torque build-up and braking torque reduction are optimally coordinated by the various brake modules. Furthermore, liability problems are solved with such a construction because the provider of an electric axle is then responsible for the entire drive and brake management.

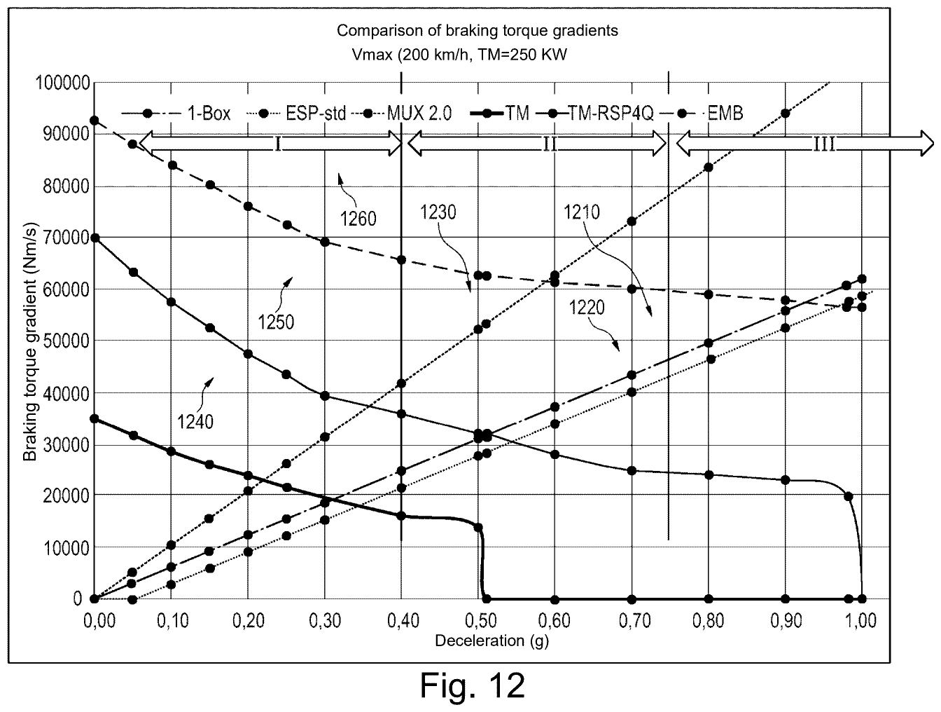

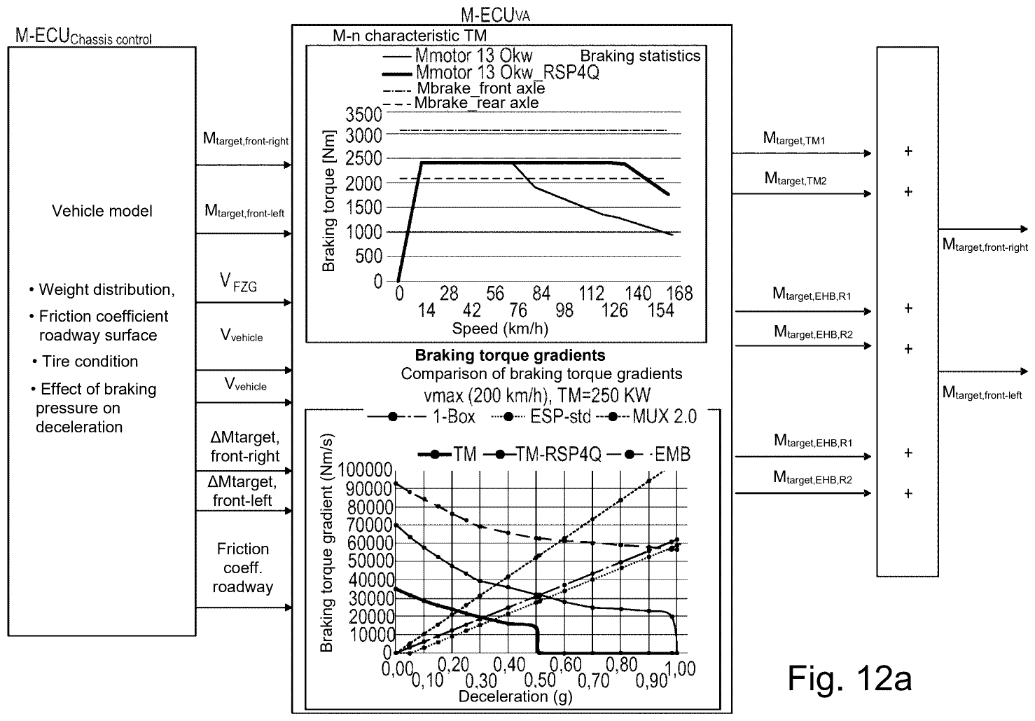

Different variants are possible in this second embodiment:
a) Electromechanical brake unit EMB combined with an electric traction drive, especially advantageous for the front axle of a vehicle (see FIG. 12a);
b) Electromechanical brake unit EMB combined with an electrohydraulic EHB pressure actuator with wheel control valves, especially advantageous for the front axle (see FIG. 12b);
c) Electric traction motors for each wheel of an axle combined with an electrohydraulic pressure actuator EHB with wheel control valves, especially advantageous for the rear axle (see FIG. 12c); and
d) Electric traction motor for one axle combined with an electrohydraulic pressure actuator EHB with wheel control valves, generally advantageous for front axle and rear axle (see FIG. 12d)

The combination of an electric motor or electromechanical brake unit EMB with the electrohydraulic brake unit EHB is especially advantageous because the advantages of the two braking torque generators can be ideally combined:
a) Electrohydraulic brake units EHB are highly dynamic in pressure reduction at high braking torques and insensitive to high braking torques, whereas electric drive motors or electromotive brake units EMB offer their greatest advantages in the braking torque gradients at low braking torques. When they are designed for greater loads, their costs also increase.
b) Electrohydraulic brake units (EHB) are substantially more cost-effective than electromotive brake units (EMB). Compared to a pressure actuator for a rear axle with wheel control valves for two wheel brakes, the costs for the EMB electromotive brake are approximately twice as high. The costs for the electrohydraulic pressure adjusters for the front axle with wheel control valves for two wheel brakes are only 10% higher, while the costs for the electromechanical brake EMB for the front axle are an additional 50% higher than for the rear axle. The reason for the disproportionate cost increase of the electromechanical brake EMB is the higher braking torques that must be achieved for the front axle and the need to provide two motors per wheel in luxury vehicles or SUVs.
c) A combination of the electrohydraulic brake unit EHB in the pressure actuator design with the PPC-Gen2 pressure control process described later with an electric traction motor or electromechanical brake units EMB can exploit the advantages of the innovative PPC-Gen2 pressure control with very precise braking torque control. Dead times in the PPC-Gen2 process, for example due to partial multiplex pressure controlled operation, can be compensated for by control using traction motors or EMB, since such brake units can achieve comparable braking torque gradients.

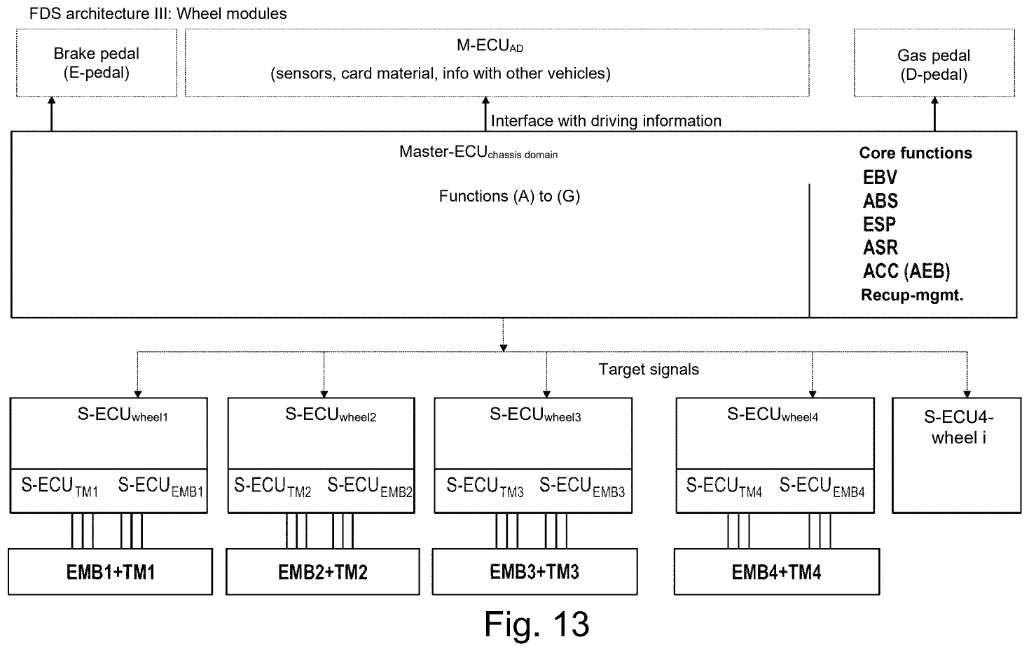

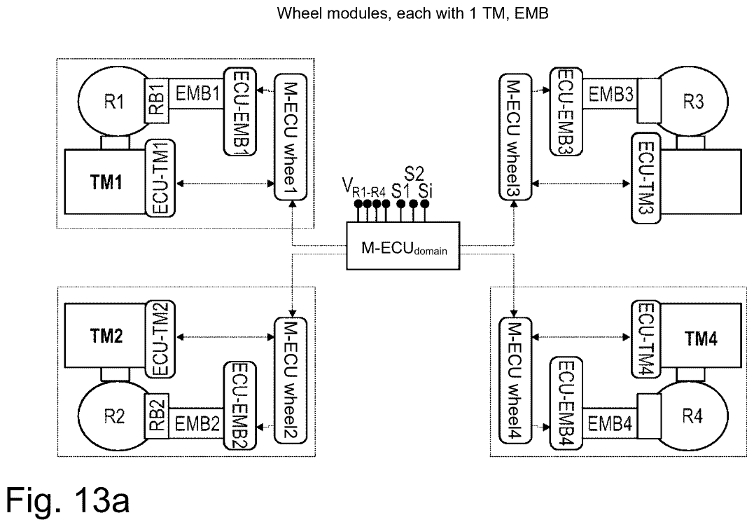

To illustrate the advantages, the achievable pressure torque gradients are further illustrated in FIGS. 13a and 13b on the basis of a powerful electric traction motor and a typical braking torque gradient of EMB, EHB with AV/EV technology and PPC Gen2 operation and will be explained in greater detail below.

The embodiments shown in FIGS. 9a and 9b, which will be explained in greater detail below, are used as the basic hydraulic principle.

The functions (a)-(g) set out in “Architecture I” can all also be carried out in “Architecture II,” and even with more degrees of freedom, because two pressure supplies with pressure control valves are available per axle, which also preferably have a redundant design.

In a third “Architecture III,” wheel modules are provided instead of a conventional electrohydraulic EHB braking system, with an electric traction motor and an electromechanical brake EMB being provided for each wheel module. Wheel modules with electric traction motors allow for a very high level of flexibility in platform design. Such a design is maximally flexible and has more redundancies than a conventional braking system, since in the event of a wheel module failure, all core functions of braking and brake control, vehicle stabilization, and steering can still be carried out with the remaining wheel modules. The disadvantage is the high cost, since an electric traction drive and an electromechanical brake unit EMB are required for each wheel. Furthermore, the electrical components are located near unsprung masses and are therefore exposed to high mechanical loads. The advantage is that the EMB can also map the parking brake function and thus reduce costs.

As explained in the first embodiment, a synchronized use of the electric traction motor and the electromechanical brake unit EMB via the driving dynamics system is advantageous, in particular when the braking power is divided in the basic braking function (in particular, see function (a) of “Architecture I”). This means that the fading effect caused by the heating of the friction brake can be prevented or reduced and, in the case of an emergency braking function AEB, the braking torques of the traction motor and the electromechanical brake unit EMB can be summed (see function (b) of the first embodiment, “Architecture 1”).

In contrast to function (g) of “Architecture I,” wheel-specific recuperation can also be implemented more easily. Axle-specific recuperation (function (c) in “Architecture 1”) can of course also be mapped.

The decisive factor is the application of function (f), in which a basic braking torque is generated in control mode via the traction motor and the braking torque is modulated in the control system by means of the electromechanical brake unit EMB. Alternatively, the basic braking torque can be generated via the electromechanical brake unit EMB, and the braking torque can be modeled via the electric traction motor. For critical driving situations (for example in the case of a u-jump), the combined braking torque can even be built up or reduced simultaneously with the electromechanical brake unit EMB and the electric traction motor, making a highly dynamic braking torque adjustment available. A joint control of the braking torques is easily possible if each wheel has a control unit (M-ECU-wheel1, M-ECU-wheel2, M-ECU-wheel3, M-ECU-wheel4) that controls the synchronized braking torque control of the EMB and the electric traction motor. This also enables time delays in braking torque changes to be minimized.

The advantage of a coordinated braking torque reduction is immense, because the technical challenges of the electromechanical brake EMB are particularly evident at high braking torques, given that the EMB tends to become deformed at high actuation torques and the release process of the brake shoes is rather problematic and leads to high costs. This problem is substantially alleviated by applying a basic braking torque via the traction motor. In addition, the support function enables the costs of the electromechanical brake EMB to be reduced considerably, and this effect increases more than proportionally with the actuating forces or braking torques. For instance, if 30% of the required base torque is provided by the electric traction motor, then the costs of the electromechanical brake EMB can be reduced by more than 30%, since the electromechanical brake EMB can be dimensioned commensurately smaller. Because of the axle load distribution during braking (typically 60-70% of the load on the front axle, 40-30% of the load on the rear axle), it is advantageous to make the electric traction motors on the front axle more powerful than the electric traction motors on the rear axle. This means that identical parts of the EMB electromotive brake units can be used for the rear and front axles, because the axle load distribution during braking is balanced out by higher braking power from the motors on the front axle.

The driving dynamics system with wheel modules is a solution that meets the requirements of SAE Level 5 due to its redundancies. However, due to the high costs (four traction motors+four electromechanical brakes), this solution is more of a niche solution for special applications from a chassis control perspective, although the additional costs are offset by other advantages, such as flexibility in the production and creation of different vehicle designs.

Another embodiment of the driving dynamics system provides for a special combi brake with hydraulic brake for the front axle with one pressure actuator for each wheel of a front axle (EHB-VR, EHB-VL) and electromechanical brake units as EMB modules (EMB1, EMB2) on each wheel of a rear axle, preferably with an integrated electric parking brake, for example through redundant design of the electronics of the EMB1, EMB2 or implementation of a self-locking mechanism of the transmissions of EMB1 and EMB2, for example using a trapezoidal spindle made of plastic. The electrohydraulic EHB-VR or EHB-VL pressure actuator can be embodied as a piston-cylinder unit without wheel control valves or simplified in the form of a pump, in particular with one gear pump per pressure actuator. If a piston pump is used—for example a 2 k pump of a standard ESP unit—at least one valve device is required to reduce the pressure, while a gear pump can take over the function of the piston-cylinder unit and can both build up and reduce braking torque.

“Architecture II” is especially suitable for the special combi brake, in which the pressure actuators of each axle are combined and the synchronization of functions a) to f) can be easily coordinated via an axle control unit S-ECU_{VA} and S-ECU_{HA}. However, another architecture is also conceivable in which the control unit of each brake torque adjuster is in communication with the central control unit M-ECU_{domain} and the central control unit transmits the target braking torques to the control electronics of the brake torque adjusters (EHB-VR, EHB-VL, EMB-HL, EMB-HR) of the wheel brakes and to at least one traction motor (TM1, TM2, TM3, TM4). Regardless of the architecture chosen, functions (a)-(g) of the driving dynamics system explained above can also be implemented, the greatest potential lying here as well in the cost and weight optimization of the friction brake, for example by using a drum brake on the front axle and a smaller disc brake on the rear axle for electromechanical brake units EMB. It is therefore especially advantageous to exploit the braking effect of an electric traction motor on the front axle for the combi brake.

The special combi solution is more complex than the solution with electrohydraulic brake units EHB-1 or EHB-ZA with wheel control valves on the front axle and electromechanical brake units EMB on the rear axle (e.g., FIG. 6c without hydraulic connection to the rear axle). However, it offers the advantage of additional degrees of freedom in positioning the EHB-VR and EHB-VL modules close to the wheels, and it enables easier scaling than with electromechanical brake units EMB on the front axle. Furthermore, it makes the manufacturer of the pressure control units, especially new companies, independent of the suppliers of solenoid valves and the technology required for pressure control with solenoid valves, which are firmly in the hands of established brake manufacturers.

In addition, the special combi brake is easier to apply, comparable to an electromechanical brake unit EMB. If a gear pump is used instead of a piston-cylinder unit, a solution can also be implemented at a reasonable cost. In particular, the cost reduction potentials by virtue of the driving dynamics system and functions (a)-(g), as will be explained below for other embodiments and architectures, are also substantial in this solution.

The following inventive objectives are pursued with the driving dynamics system control of Architectures I-III as well as with the special combi brake with great functional, redundancy, and cost advantages:

### Improvement Function/Application/Novel Features:

Use of electric traction motors in ABS mode, particularly on a roadway with low coefficients of friction (snow, ice) in control mode to shorten the braking distance, where the larger braking torque gradients of the electric traction motors have advantages compared to known ABS systems with reservoir (compare standard ESP systems with slow pressure reduction in a reservoir).
Use of electric traction motors for ASC operation through torque control and motor speed control when starting off instead of the known solutions by braking the rear wheel using the electrohydraulic brake EHB.
Improvement of the emergency braking function AEB with increase in braking torque to 100 ms instead of 150 ms with the corresponding shortening of the braking distance, particularly at high speeds and risk of collision.
Combined yaw moment interventions for vehicle stabilization or steering by using torque interventions generated by the electric traction motor and a braking torque by an electrohydraulic brake unit EHB.
Combined braking interventions in control mode by the electric traction motor and electrohydraulic brake EHB, for example in the event of dynamic changes in the roadway characteristics, such as a u-jump, where rapid pressure reduction is required.
ABS control with electrohydraulic brake unit EHB in the multiplex process with torque control via electric traction motors, thus avoiding dead times in the multiplex system.
Utilizing the advantages of the closed hydraulic braking system for rapid application of the core functions ABS and ESP and automation of new software functions via central over-the-air updates, for example implementation of software upgrades when transitioning from SAE Level 2 to SAE Levels 3-5.
EBD control with electric traction motor on the rear axle and electrohydraulic brake EHB on the front axle.
Implementation of a redundant ASC function through the electric traction motor or the electrohydraulic brake unit EHB.

### Advantages Through Cost and Weight Reduction:

Use of electric traction motors to reduce the thermal load on the brake calipers during multiple braking (so-called AMS fading test) and thereby downsize the electrohydraulic braking system, for example designing the electrohydraulic brake unit EHB at the locking pressure with an additional reserve of 20-40%, i.e., 120-140 bar, instead of 200-200 bar, optionally even designing for lower pressures than the required locking pressure (60-80 bar) with successful implementation of the brake via electric traction motors with reliable energy management even with a full battery.
Use of electric traction motors to reduce the thermal load on the brake calipers and enable the use of cost-effective drum brakes on the rear axle.
Reduction of fine dust and wear on the braking systems by braking primarily using electric traction motors.
Downsizing of the electromotive brake unit EMB through braking torque assistance by the electric traction motor, particularly on the front axle of the vehicle, but also the rear axle.
Use of an electrohydraulic brake EHB with a simple 2-component pump with relatively low power instead of a 1-box with a powerful EC motor and implementation of the emergency braking function in 150 ms through the corresponding power of the electric traction motors in combination with a standard ESP device with TTL=500 ms.
Use of smaller solenoid valves by mapping highly dynamic pressure build-ups using the electric traction motor.

### Improvement Through Redundancy:

Use of the electric traction motor for braking in the event of a failure or partial failure of the braking system.
Use of the electric traction motor to maintain rapid emergency braking AEB with TTL=150 ms even if the primary braking system fails.
Use of the electric traction motor to maintain the EBD function even if the rear axle brake circuit fails.
Use of the electric traction motor in the event of a brake circuit failure.
Use of the electric traction motor if the ESP function fails.
Use of the electric traction motor in the event of a steering function failure or support of steering interventions on the front axle through yaw moment interventions on the rear axle.
Implementation of a redundant ASC function by the electric traction motor or an electrohydraulic brake unit EHB

The invention is described below on the basis of multiple exemplary embodiments, which will be explained in greater detail with reference to figures. In the figures:

FIG. 1a: Fading effect in the AMS test as a basis for the design of a standard braking system;

FIG. 1b: Blending strategy with regenerative brakes according to the prior art without driving dynamics system;

FIG. 2a: Driving dynamics system “Architecture I”: Hydraulic braking system EHB-Z, EHB-VA in combination with electric traction motors TM1, TM2, TM3;

FIG. 2b: Driving dynamics system “Architecture I”: Hydraulic braking system in combination with electric traction motors;

FIG. 3 Novel blending strategy with driving dynamics system and powerful electric traction motor or powerful electric traction motors;

FIG. 4 AEB time savings with braking via electric traction motor and electrohydraulic brake unit EHB with adapted EBD function;

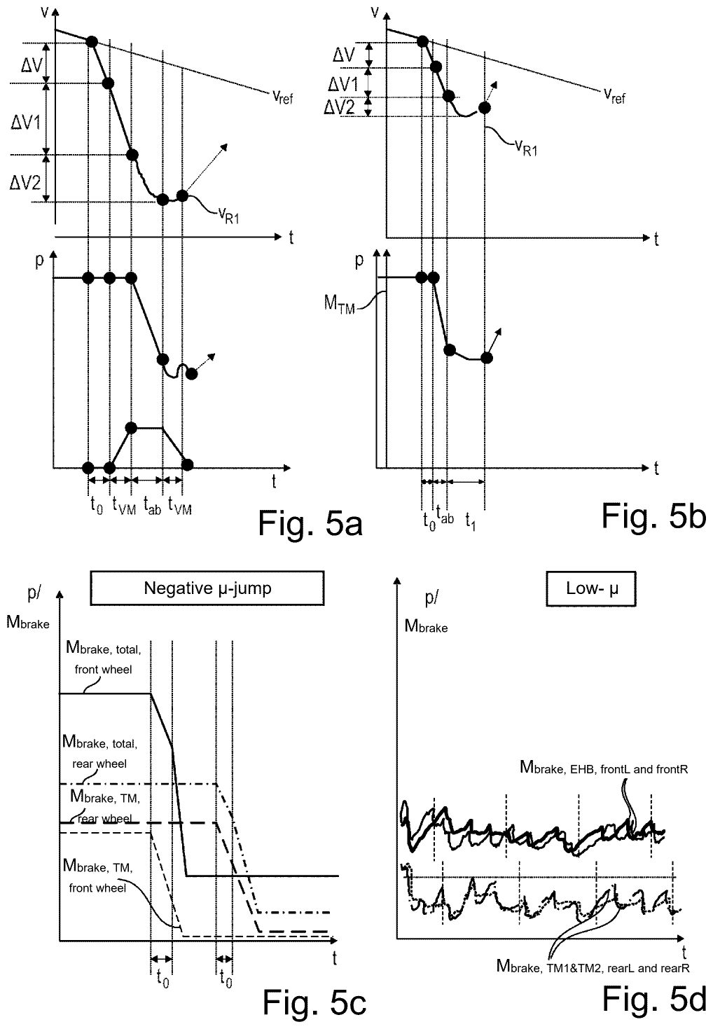

FIG. 5 ABS control mode with electrohydraulic brake unit EHB and generation of the basic braking torque by electric traction motor;

FIG. 5a: Typical ABS time curve with wheel speed, pressure, and valve times for brake torque control with electrohydraulic brake unit EHB;

FIG. 5b: Optimized ABS time curve with wheel speed, pressure, and valve times with brake torque control with electric traction motor;

FIG. 5c: ABS control mode in the case of a μ-jump with electrohydraulic brake unit EHB in combination with electric traction motor;

FIG. 5d: ABS control mode in case of low-μ with electrohydraulic brake unit EHB in combination with electric traction motor on the rear axle;

FIG. 6a: Design A for driving dynamics system “Architecture I”: EHB-Z for wheel-specific control for the front axle and the rear axle in combination with electric traction motor on the front axle and the rear axle;

FIG. 6b: Design B for driving dynamics system “Architecture I”: EHB-Z for wheel-specific control for the front axle in combination with a basic braking torque for the rear axle, ABS control on the rear axle by means of electric traction motors;

FIG. 6c: Design B for driving dynamics system “Architecture I”: EHB-Z for wheel-specific control for the front axle in combination with a basic braking torque for the rear axle, ABS control on the rear axle by means of the electromechanical brake unit EMB;

FIG. 6d: Design D for driving dynamics system “Architecture I”: EHB-VA for individual wheel control of the front axle, brakes and ABS control on the rear axle exclusively with electric traction motors;

FIG. 7a: 250 KW motor characteristic map with powerful motor & power boost via innovative RSP-4Q inverter;

FIG. 7b: Construction of a novel RSP-4Q inverter;

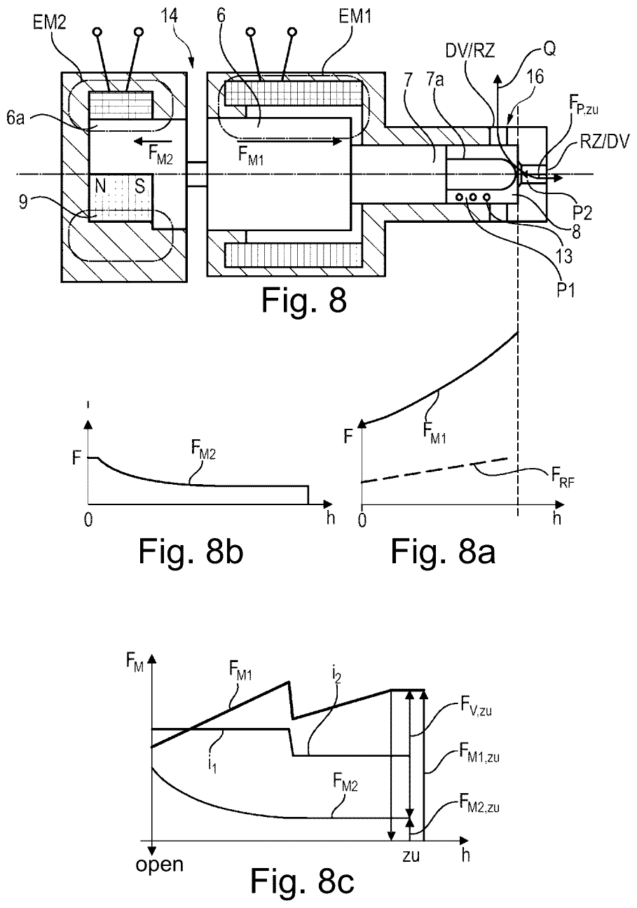

FIGS. 8-8c: Normally open inlet/outlet valve MV₂ₖ for pressure build-up and pressure reduction at high pressure gradients and braking pressures;

FIG. 9a: Novel pressure control with inlet/outlet valve MV_{2K} (PPC-Gen-V1);

FIG. 9b: Novel pressure control with inlet/outlet valve MV_{2K} (PPC-Gen2-V2);

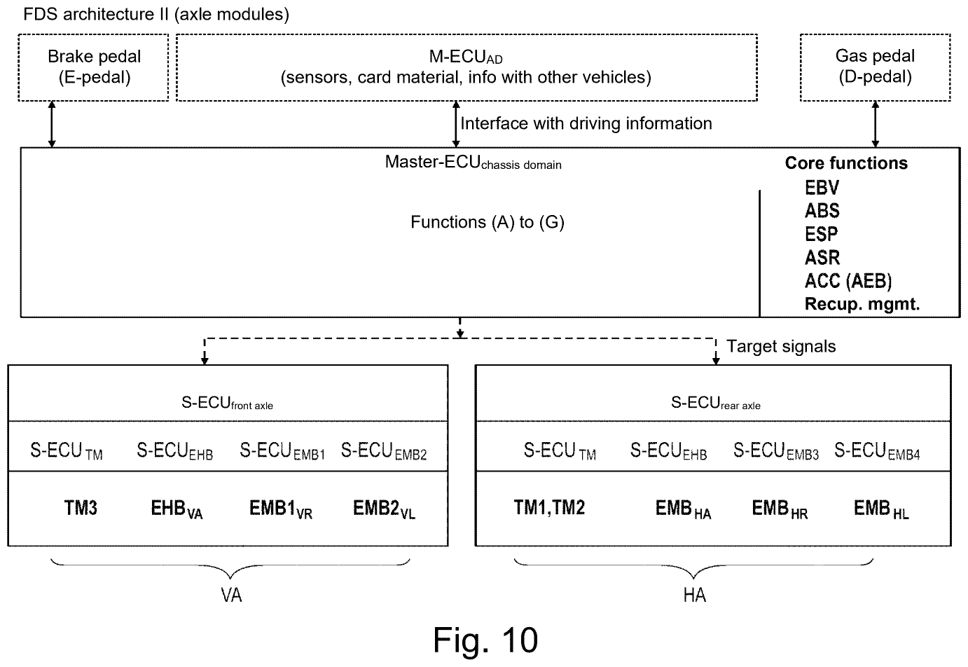

FIG. 10: Driving dynamics system “Architecture II”: Electric axle modules with axle control electronics S-ECU_{VA} and S-ECU_{HA};

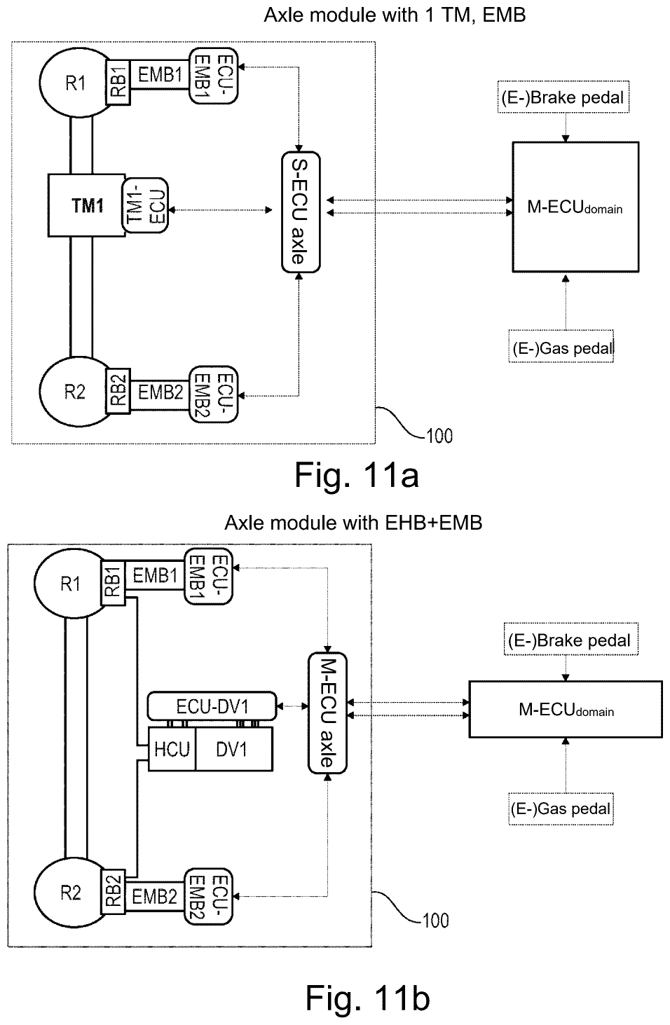

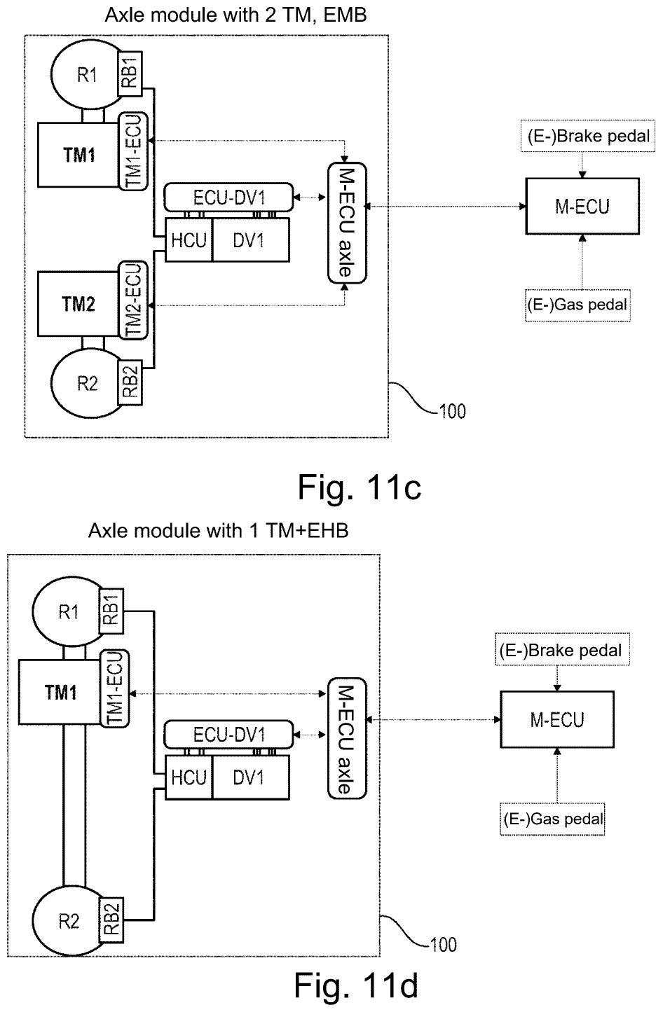

FIG. 11a: Driving dynamics system “Architecture II”: Electric axle module I with two electromotive brake units and an electric traction motor;

FIG. 11b: Driving dynamics system “Architecture II”: Electric axle module II with one electrohydraulic brake unit and two electromotive brake units;

FIG. 11c: Driving dynamics system “Architecture II”: Electric axle module III with an electrohydraulic brake unit and an electric traction motor;

FIG. 11d: Driving dynamics system “Architecture II”: Electric axle module IV with an electrohydraulic brake unit and two electric traction motors;

FIG. 12 Comparison of braking torque gradients of electric traction motor TM, electrohydraulic brake unit EHB, electromotive brake unit EMB, and operating ranges;

FIG. 12a: Decision heuristics with evaluation of characteristic maps, core data, and signals;

FIG. 13 Driving dynamics system “Architecture III”: Wheel modules with wheel control electronics for electromotive brake unit and electric traction motor; and

FIG. 13a: Driving dynamics system “Architecture III”: Wheel modules with four electric brake units and four electric traction motors.

FIG. 1d shows a typical simulation of an AMS test according to which a braking system is designed according to the prior art. In this simulation, 10 subsequent braking maneuvers from 100 km/h are simulated. If the so-called AMS fading test is used to determine the maximum pressure (Bremsenhandbuch [Brake Technology Handbook] 5th edition, chapter 6.3.2, FIG. 6.10), the wheel brakes on the front axle typically heat up to around 600° C. and the wheel brakes on the rear axle to around 500° C. The pedal force with standard vacuum brake boosters then increases by around 80%, which means that the braking system must be designed for a pressure that is 80% higher in the event of fading than would be required for the normal locking pressure. With an appropriate safety reserve, typical braking systems are therefore designed for a maximum pressure of 200-220 bar.

FIG. 1e shows the currently commercially available brake management with electrohydraulic brake combined with an electric traction motor. The process is described in greater detail in Bremsenhandbuch [Brake Technology Handbook], 5th edition, chapters 19.3.2 and 19.3.3, and is shown in FIG. 1a. This management has now been expanded as one of the core ideas of the invention. It is characteristic that hydraulic braking is used at the beginning of braking at low vehicle speeds (Range B), while regenerative braking is gradually increased at speed v₁ and gradually reduced up to speed v₂; this means that, at a low vehicle speed (v₁<10 km/h, Range B) and high vehicle speed (v₂>60 km/h, Range E2, D), braking is performed hydraulically, not regeneratively. What is more, the available potential of regenerative braking, for example stronger braking above the braking torque of M max between v₁ and v₂ and regenerative braking in the speed range>v₂, is not fully exploited. This means that, although a higher braking torque could be available up to M_{max,TM}, this is not exploited in this speed range (Range E1). This is often due to technical reasons, for example if the braking system used is not designed for greater recuperation. In the system described in DE 10 2012 211 278 A1, for example, this is limited by the fact that the reservoir of the ESP-hev unit can only hold a limited volume, which means that blending is limited.

At greater decelerations and speeds, safety aspects also play a role: For example, regenerative braking is not used if, in the event of ABS, the braking torque of the electric traction motor might result in the wheels locking; in that case, the driving dynamics system of the invention provides a remedy by centrally controlling the electric traction motor and the electrohydraulic brake unit. Therefore, the blending strategy according to the prior art does not provide for regenerative braking in Ranges E1 and E2.

For the reasons mentioned above, the potential of regenerative braking and the optimization of the friction brake for the AMS fading case is not fully exploited in known systems, since the AMS fading case occurs precisely at a speed of about 100 km/h and during emergency braking. According to the prior art (see FIG. 1), braking is purely hydraulic. If, for example, 30% of the braking power in the AMS test were to be taken over by the electric traction motor (M_{el.TM,AMS}), the fading effect would be reduced substantially, since the heating of the braking system would be significantly lower. The braking system could then be designed for a significantly lower maximum pressure, around 140-160 bar. Maximization using the driving dynamics system control according to the invention would have three effects with significant cost and weight savings:
1. Regeneration could be maximized, which extends the range of electric vehicles and can be used to operate heat pumps;
2. The friction brake could be simplified, for example through easier cooling, less wear, and smaller brake discs, and inexpensive drum brakes could replace disc brakes;
3. Downsizing of the electrohydraulic brake would be possible, in particular with a smaller EC motor for lower maximum torques, a design of the wheel control valves for lower maximum pressures, a weight reduction of the electrohydraulic brake unit EHB, and a smaller volume of the pressure supply unit of the electrohydraulic brake unit.

FIG. 2 shows the advantageous driving dynamics system “Architecture I” for joint operation of electric traction motors on the front axle (TM3) and/or on the rear axle (TM1, TM2) combined with an electrohydraulic braking system of the topology EHB-Z or EHB-VA according to FIG. 2. The central control unit controls the braking torques of the electric traction motors TM1, TM2, TM3 and the electrohydraulic brake units EHB-Z, EHH-VA for at least one of the following functions:
(A) Basic brake with thermal management and energy management of the supplied and dissipated energy (electrical energy, thermal energy) of the traction motor;
(B) Emergency brake AEB with electronic brakeforce distribution (EBD);
(C) Regenerative braking on multiple axles;
(D) ABS control with basic brake torque assistance and/or common brake torque control;
(E) Braking operation in the event of failure of the electrohydraulic brake unit EHB-Z, EHB-VA;
(F) Yaw moment interventions by means of wheel-specific braking torque interventions; and/or
(G) wheel-specific braking torque interventions for wheel-specific regenerative braking.

The driving dynamics system sends target values to the various units, the target values including, in particular, target braking torques or target braking pressures.

For certain functions (such as functions (C), (E), (F) described above), target signals for pressure control or pressure regulation are also specified, such as control signals for solenoid valves for functions such as switching duration of the opening time or a PWM frequency during throttling operation, and/or system pressures for the pressure supply device for pressure build-up or pressure reduction.

Furthermore, the M-ECU_{domain} can also have an interface to the control unit or domain of autonomous driving M-ECU_{AD} and can evaluate additional information that is helpful for effective and predictive control. This includes camera information about the condition of the roadway (snow, ice, rain) or information about the surroundings (distances to pedestrians and/or other vehicles).

FIG. 2a shows the exemplary construction of a vehicle architecture with the driving dynamics system with hydraulic lines and signal lines between the units and sensors. The central control unit M-ECU_{domain}, preferably comprising three microcontrollers μC1, μC2, μC3 for the implementation of a 2-out-of-3 architecture, communicates with the control unit of the electrohydraulic brake unit (M-ECU_{BM}) as well as with the electric traction motors TM1, (optionally TM2) of the rear axle and with the electric traction motor TM3 of the front axle, in particular via redundant data lines.

The central control unit M-ECU_{domain} can, in particular, have at least one very powerful microcontroller and a large memory (dimensioned in the gigabyte range) so that an automatic application can be implemented by means of artificial intelligence (AI) before the vehicle is first put into operation and/or during vehicle operation. Alternatively, a central processor can be used instead of a domain processor, or the typically greater resources of a central processor designed for processing multimedia data can be used, particularly for the application via AI.

The central control unit M-ECU_{domain} receives data from wheel speed sensors of the wheels v_{R1}-v_{R4} and preferably further sensor signals S1, S2, Si, etc. The sensor signals S1, S2, Si can be provided by yaw moment sensors, acceleration sensors, and/or weight sensors, which are important for the central control of a vehicle model because these sensors enable or at least facilitate the optimization of the central control. The weight sensor can be advantageously used to adapt the recuperation strategy as a function of the weight. Yaw moment sensors are helpful for driving dynamics interventions, such as torque vectoring or ESP yaw moment interventions, and acceleration sensors help calibrate the relationship between the braking pressure of a hydraulic brake unit (EHB) and the achieved braking torque or braking pressure and vehicle deceleration achieved. Additional sensors or data from the autonomous driving system, such as data from cameras and LIDAR sensors, map material, or data in the interaction with the environment and other vehicles, for example in Car2X (V2x) or Car2Car (V2V) communication, can also be used to implement traffic-specific braking torque interventions or to decelerate the vehicle in a targeted manner and, in the event of a fault—for example in the event of a partial failure with reduced maximum deceleration—to operate the vehicle at an adjusted speed or to decelerate early.

In addition, the electric power steering EPS on the front axle and optional electric parking brakes (EPB1, EPB2) on the rear axles are advantageously provided for communication with the central domain. The integration of the EPS makes coordinated driving dynamics interventions possible, such as torque vectoring, ESP yaw moment interventions via the electrohydraulic brake unit EHB in addition to the steering, for example in order to support the vehicle's electric power steering in the event of failure or partial failure of the EPS. In addition, the integration of the electric parking brake EPB is advantageous because, in addition to ensuring a standstill, the parking brake can also perform dynamic braking functions or emergency functions, as described in WO 2020165255 A1.

FIG. 2b shows the exemplary construction of another vehicle architecture of the driving dynamics system according to the invention, with EHB-Z with hydraulic lines and signal lines between the brake units and sensors. The central control unit M-ECU_{domain}, preferably comprising three microcontrollers μC1, μC2, μC3 for the implementation of a 2-out-of-3 architecture, communicates with a control unit of the hydraulic brake unit (M-ECU_{BM}) with two redundant control units ECU1_{EHB} and ECU2_{EHB} as well as with the electric traction motors TM1, TM2 of the rear axle and with the electric traction motor TM3 of the front axle, in particular via redundant data lines. In contrast to FIG. 2b, no pedal is integrated into the EHB-Z, and only one hydraulic line to the wheel brakes of the rear axle is provided as well as one electric traction motor for each wheel of the rear axle, so that the braking torque control for different functions ABS, ASC, ESP, EDB and regenerative braking is carried out by the electric traction motors, while the electrohydraulic brake unit EHB-Z only provides a basic braking torque. Further details on the hydraulic layout of the EHB-Z are shown in FIG. 6b.

In the central control units M-ECU_{domain}, data from wheel speed sensors of the wheels v_{R1}-v_{R4} are received as well as preferably from further sensor signals S1, S2, Si, etc. The sensor signals S1, S2, Si can be provided by yaw moment sensors, acceleration sensors, and/or weight sensors, which are important for the central control of a vehicle model because these sensors enable or at least facilitate the optimization of the central control. The weight sensor can be advantageously used to adapt the recuperation strategy as a function of the weight. Yaw moment sensors are helpful for driving dynamics interventions, such as torque vectoring or ESP yaw moment interventions, and acceleration sensors help calibrate the relationship between the braking pressure of a hydraulic braking system (EHB) and the braking torque or braking pressure and vehicle deceleration achieved. Additional sensors or data from the autonomous driving system, such as data from cameras and LIDAR sensors, map material, or data in the interaction with the environment and with other vehicles, for example in Car2X (V2x) or Car2Car (V2V) communication, can also be used to implement traffic-specific braking torque interventions or to decelerate the vehicle in a targeted manner and, in the event of a fault—for example in the event of a partial failure with reduced maximum deceleration—to operate the vehicle at an adjusted speed or to decelerate early.

In addition, the electric power steering EPS of the front axle and, optionally, also the electric parking brakes (EPB1, EPB2) of the rear axles are advantageously provided for communication with the central domain. The integration of the EPS enables coordinated driving dynamics interventions, such as torque vectoring or ESP yaw moment interventions via the hydraulic brake unit EHB in addition to the steering or to support the vehicle's electric power steering in the event of failure or partial failure of the EPS. In addition, the integration of the electric parking brake EPB is advantageous because, in addition to ensuring a standstill, the parking brake can also perform dynamic braking functions or emergency functions, as described in WO 2020165255A1.

FIG. 3 shows the blending strategy of the driving dynamics system with full utilization of the braking force of an electric traction motor over the entire speed range of the vehicle and up to the maximum braking torque of the electric traction motor used. Full utilization of the driving dynamics system is possible because, as shown in FIG. 2a, the central domain has all the important information and can therefore very quickly adjust the braking effect via the electric motor with minimal time delay in a critical driving situation, such as during ABS control mode. New types of electric motor using high-voltage technology (>700 V) can increase or reduce the electric braking torque via the electric motor very dynamically by 10,000 to 30,000 Nm/s. In a case with ABS, the electric traction motor on the axle with electric axle drives (see table) or with a wheel with individual wheel drive or with electric axles with torque vectoring modules can therefore reduce the braking torque almost as quickly as with a hydraulic brake (typically 1,000 to 2,000 bar/s=20,000 to 40,000 Nm/s) before the electrohydraulic brake unit EHB takes over the ABS control. A control strategy in ABS mode together with electric traction motor and the electrohydraulic brake unit EHB is further outlined in FIG. 5a. This means that the first control cycle is not entirely optimal, but there is no safety-critical situation in which the vehicle could become unstable. Furthermore, in critical driving situations in which an automatic emergency brake (AEB) is used, the disadvantages of the first control cycle can be overcompensated for by shortening TTL.

In the illustration, the torque-speed characteristic map of an electric drive motor of a plug-in hybrid or electric vehicle (e.g., BMW i3) with a vehicle weight of 1365 kg was used as an example. In this case, the electric traction motor has a maximum output of about 130 KW and a maximum torque of 250 Nm and operates with a gear ratio of 9.5, which means that a torque of up to 2400 Nm can be used on the axles of a vehicle for propulsion and deceleration. Assuming a maximum permissible vehicle weight of 1710 kg and a weight distribution when braking with maximum deceleration of 40% on the rear axle and 60% on the front axle, an axle braking torque of 3400 Nm on the front axle and 2465 Nm on the rear axle is required. This means that the rear axle can be braked fully electrically up to a speed of approx. 70 km/h.

At the speed point for the AMS fading test-100 km/h-approximately 50% of the braking power can be achieved on the front axle and even almost 70% on the rear axle. This in turn means that the brake on the front axle only experiences half the friction power and the rear axle only 30%.

The high additional braking torque available over a wide speed range can be used to significantly reduce the heating of the friction brake, in addition to the AMS test conditions at 100 km/h even at high speeds, where a lot of kinetic energy is absorbed by the friction brake. The latter is advantageous for sports vehicles in which very expensive ceramic brakes are typically used. In addition, the rear axle can be thermally relieved completely in the speed range up to 70 km/h; it can also be relieved to a very high extent, particularly including during the critical AMS test. This makes the use of a cost-effective drum brake possible.

The central control unit of the driving dynamics system, which preferably also determines the weight of the vehicle, can then increase braking via regenerative braking even when the load is low, meaning that the recuperation strategy is adapted as a function of the vehicle load.

The battery's ability to absorb high pulse power is problematic, particularly when it is at high charge levels. In this special case, it is advisable not to feed the power back into the battery, but to dissipate it internally at least in part in the electric traction motor by means of intelligent field-oriented vector control (Id, Iq), so that no energy is fed back. Alternatively, an additional resistor can be used to dissipate the heat. The heat generated via a resistor can then be advantageously used for heating the vehicle or, via a heat exchanger, for cooling the vehicle. The possibilities for energy management have already been described in additional detail above.

If a special inverter is also used by means of which the motor windings can be connected alternatively in series or parallel (RSP-4Q inverter), an additional torque boost is possible at higher motor speeds or at higher vehicle speeds. This also enables the braking torque to be increased in order to generate braking at higher vehicle speeds, thereby recuperating even more kinetic energy. Alternatively, the TTL (time-to-lock) can be further reduced at high speeds, as shown in FIG. 4, which can also be advantageously used to shorten the braking distance, since electrical braking can be used in addition to the hydraulic brake.

FIG. 4 illustrates how the inventive function of the emergency brake AEB (function B) can be implemented with the inventive control of the driving dynamics system by expediently adapting the EBD control in the electric emergency brake in addition to the braking effect via electric traction motors in order to shorten the braking distance. FIG. 4 shows an example of an electric traction motor with the performance data of FIG. 3 (130 kW, 250 Nm, gear ratio of 9.5) and a torque gradient of 15,000 Nm/s. The electrohydraulic EHB system is based on a black and white brake circuit division, i.e., one brake circuit for the front axle and a second brake circuit for the rear axle of the vehicle. The curves BM_{TM1-VA} and BM_{TM2-HA} show the increase in braking torque of the electric traction motor on the front axle VA and rear axle HA, respectively, in particular with a braking torque gradient of 15,000 Nm/s. This increase is taken into account for the electronic brakeforce distribution (EBD) in such a way that the pressure curve is distributed to the front axle and the rear axle via an advantageous hydraulic braking system, as further outlined in FIG. 6, such that the front axle and the rear axle reach their maximum braking torque, for example for 1 g deceleration, simultaneously and, at the same time, it is ensured that design priorities (see Table 1 of the priorities) are taken into account.

In simplified terms, the braking torque continues to increase after the maximum braking torque has been reached (indicated in the figure as approximately 1 g) in order to illustrate the further temporal braking torque curve and thus also to illustrate TTL for greater decelerations (e.g., up to 1.4 g for sports vehicles). If an ABS case occurs, typically at a deceleration of about 1 g, the braking torque is subsequently reduced and ABS control mode follows, as will be further explained below with reference to FIGS. 5, 5a, 5b, 5c.

The curve BM_{EHB-HA} shows the braking torque curve for the electrohydraulic brake of the rear axle; the curve BM_{HA,EHB+TM2-HA} Shows the sum of the braking torque curve for the electrohydraulic brake of the rear axle and the traction motor TM2 associated with the rear axle.

The curve BM_{EHB-VA} also shows the braking torque curve for the electrohydraulic brake of the front axle; the curve BM_{VA,EHB+TM1-VA} shows the sum of the braking torque curve for the electrohydraulic brake of the front axle and the traction motor.

The braking torque corresponding to the locking pressure for the front axle VA is shown as an upper horizontal line BLM-VA. The braking torque corresponding to the locking pressure for the rear axle HA is shown as a lower horizontal line BLM-HA.

The respective locking pressure is obtained where the curves for the braking torque achieved by the brake units EHB-VA, TM1, EHB-HA, TM2 intersect with the horizontal lines BLM-VA, BLM-HA. The time until this point is reached is called time-to-lock (TTL).

The TTL for the electrohydraulic brakes EHB-VA, EHB-HA alone is approximately 140 ms, whereas it is approximately 90 ms when additionally using the regenerative braking torques of the traction motors TM1, TM2. This means that, by controlling the driving dynamics system, the TTL in the simulation can be reduced by a difference ΔT from 140 ms to 95 ms, which has a significant impact on the braking distance. At a speed of 100 km/h, for example, these 45 ms correspond to a distance covered of about 1 m. This is already a significant improvement compared to typical braking distances of 25 m with ABS braking.

Such an improvement in braking distance by 1 m is a very ambitious goal for ABS braking system applicators.

FIG. 5 illustrates another fundamental idea of the synergistic use of the braking torques of electric traction motors and the braking torques of electrohydraulic brake units using a typical ABS control curve at high pressures on asphalt, i.e., in the so-called “high-μ case.”

Since, as already explained above, a traction motor can build up and reduce braking torque very quickly, the use of the electric traction motor in ABS control is unproblematic.

FIG. 5 shows a curve for the deceleration of the vehicle, as well as curves for the wheel speeds of the four wheels of the vehicle.

Advantageously, the electric traction motor generates a basic braking torque VA in ABS mode, which is shown in FIG. 5 for an exemplary arrangement of the electric traction motor on the front axle. This means that the system pressure of the electrohydraulic brake unit EHB can be reduced by the basic braking torque of the electric traction motor. As a result, the locking pressure can be generated more quickly, as shown in FIG. 4, and the required pressure of the EHB for ABS control is reduced.

This can be exploited in order to downsize the braking system, which usually has to generate a system pressure that is 20-40% higher than the maximum wheel pressure. However, if 50% of the basic braking torque is generated via the electric traction motor, only a pressure of 70-80 bar is required for ABS mode instead of the typical design of 120-140 bar. Since the heating of the braking system is significantly reduced by generative braking (see the above explanation with reference to FIG. 3), a design of the EHB at 100 bar is sufficient for safe controlled operation.

FIG. 5 illustrates how the basic braking torque on the front axle VA is provided by the electric traction motor. The difference ΔP from the desired system pressure for the front axle VA is then relatively small. The pressure control for the two wheels of the front axle VA compensates for variations with a small amplitude, enabling the electrohydraulic brake unit to be made smaller.

This has significant effects on the braking system, since the pressure supply requires a smaller volume to provide the necessary fluid volume and the electric motor of the electrohydraulic brake unit EHB can only generate 50% of the braking torque. In addition, the valve design of the Hydraulic Control Unit (HCU) of the EHB can be adapted by using smaller or less expensive valves that can be designed for a significantly lower pressure resistance. With these basic ideas, the costs of an EMS can be reduced by about 10%. In addition, the friction brake can be designed much more cost-effectively, because the thermal load is reduced and less braking torque needs to be transferred to the brake shoes. In sports vehicles, expensive ceramic brakes can be replaced by substantially more cost-effective gray cast iron brakes.

FIGS. 5a and 5b show the delays of ABS control with electric traction motors compared to standard ABS systems. The temporal sequences of the wheel speed vR1 of a wheel are illustrated for comparison.

FIG. 5a shows a typical sequence at the beginning of a control cycle of pressure reduction in ABS mode with a standard ESP system or a 1-box system, shown on a low coefficient of friction, for example on snow.

In the upper diagram, the wheel speed is plotted as a function of time t. In the lower diagram, the pressure is plotted as a function of time t (upper curve); furthermore, the opening state of a valve over time t is shown schematically (lower curve).

After a time t₀, the locking of a wheel is detected due to a dead time of the system, since the wheel speed v deviates from the reference speed v_{ref} by v. The outlet valves are then opened to reduce the pressure. A time t_{VM} passes until the valve is opened. During this time phase, the wheel speed continues to fall by Δv₁. After the valve opening phase, the pressure is reduced over the time period tab, which is represented linearly for simplicity. During this time phase, the wheel speed continues to fall by Δv2 until the wheel stabilizes. The valve is then closed again. This is followed by a gradual pressure build-up (not shown) in order to bring the wheel speed back to the level of the reference speed v_{ref}, which is preferably carried out via small gradual pressure increases via inlet valves.

FIG. 5b shows ABS control of a wheel using traction motors.

The upper diagram shows the wheel speed as a function of time t. The lower diagram shows the pressure as a function of time t.

If the ABS control with traction motors described here preferably uses wheel speed sensors with high resolution and short latency times for data transmission to the central control unit M-ECU_{domain}, an ABS case, characterized by a wheel speed deviation from the reference value, can be detected more quickly, particularly due to precise modeling of a vehicle model in the central processor. As a result, the delay time to is shorter with the inventive control of the driving dynamics system, and the speed difference Δv is therefore also smaller. Furthermore, since no valve is required for ABS control with electric traction motors, and the time delay of the torque change in an inverter of a powerful traction motor is negligible, the braking torque reduction takes place without any further time delay t_{MV} immediately after the initial deceleration to, especially with a low road coefficient of friction with a larger braking torque gradient (see illustration of the braking torque gradients in FIG. 12). Furthermore, due to the higher resolution, an improved wheel acceleration control with central domain control can be implemented, enabling the target wheel torque to be reached faster and without overshoot. If the increase in braking torque then follows without delaying the valve actuation and also with the precision of a motor control with torque and motor speed control cascade (particularly while taking into account the torque/current of the electric motor of the pressure actuator, the position of a piston in a piston-cylinder system of the pressure actuator, and an actuator speed, i.e., a speed of adjustment of a piston of the pressure actuator), the reference speed v_{ref} is also reached again much faster without oscillations in the braking torque curve. Due to the smaller deviations in the reference speed, the braking distance can be reduced when controlling with electric traction motors in the ABS compared to a standard ABS system while at the same time reducing noise due to the low pressure oscillation control. To put it another way, the same control quality can be achieved with smaller braking torque gradients when controlled by traction motors compared to braking torque gradients of an electrohydraulic brake unit EHB, because the critical time delay t_{vM} caused by the solenoid valves is eliminated. In addition, the powerful processor and wheel speed sensors with higher resolution can reduce the reaction time to, which means that a wheel lock is detected earlier and can be corrected more quickly.

FIG. 5c shows a further advantage of the joint braking torque modulation during controlled operation according to the invention using the example of a negative u-jump, e.g., when the vehicle goes from asphalt to snow, for instance.

FIG. 5c shows the pressure or the corresponding braking torque at the front axle VA and at the rear axle HA as a function of time t. Curves are shown for the braking torques generated by the traction motors on the front axle and rear axle as well as the total braking torques on the front axle and rear axle.

In FIG. 5c, it is assumed for simplicity that both wheels of the front axle have the same braking torque or the same braking pressure and that both the front axle and the rear axle have a traction motor on the axle that contributes a basic braking torque to the total braking torque of the respective axle. The braking torque of the traction motors M_{brake,TM,front wheel} or M_{brake,TM,rear wheel} and the hydraulic braking torque (not shown) of the electrohydraulic brake unit EHB of the front wheels or the rear wheels act additively to the total braking torque M_{brake,tot,front wheel} or M_{brake,tot,rear wheel}.

When reducing the braking torque, the braking torque of the front axle M_{brake,TM,front wheel} can be reduced first without any time delay, followed by the pressure reduction by the EHB with the time delay to described above. This enables the braking torque to be adjusted very quickly, and the gradient increases as soon as the EHB can reduce the pressure. This has a positive effect on the speed reduction of the front wheels, which is not shown. After a short time delay, the braking torque reduction on the rear axle or the reduction of the braking torque M_{brake,tot,rear wheel} follows, which—as described above for the front axle-benefits from the rapidly occurring braking torque by the electric traction motor M_{brake,TM,rear wheel} without any further time delay to, so that, here as well, the wheel speed does not drop as sharply.

FIG. 5d shows the approach according to the invention for a different control situation in which the vehicle is operated on a largely homogeneous roadway, for example with snow (so-called low-μ case).

The braking torque M_{brake} generated at the front right VR, front left FL, rear right HR, and front right VR wheels is plotted as a function of time t.

Here, the front axle is advantageously controlled with the EHB, while the lower braking torques for the rear axle are obtained by the two traction motors TM1 and TM2, the concept of the following FIG. 6b or 6d being used as a basis.

Alternatively, the control can also be applied to drive concepts in which an electromechanical brake unit EMB is provided on the rear axle according to the concept in FIG. 6c and an electrohydraulic brake unit EHB is provided on the front axle. An electromotive brake unit (EMB) has comparable advantages to traction motors, such as a high braking torque gradient and precise braking torque control through the torque and acceleration control of the EMB motor. The electromotive brake EMB is even superior to electric traction motors in terms of braking torque gradient (see illustration in FIG. 12). In addition, the brake shoe deformation effect of the EMB is eliminated at low coefficients of friction.

FIG. 6a shows a hydraulic braking system for four wheel brakes and with electric traction motors TM1 on the rear axle and TM2 on the front axle of the vehicle, which is advantageous for integration into the driving dynamics system according to the first embodiment (“Architecture I”). This braking system can also have a redundant pressure supply in the form of a piston-cylinder unit driven by an electric motor and spindle drive. The pressure supply can be equipped with a current sensor i/U and an angle sensor a/U as well as, optionally, with temperature sensors T/U which measure the motor temperature of the EC motor. The piston-cylinder unit can also have redundant phase connections, redundant electronics, and/or redundant on-board network connections BN1 and BN2 and data lines DS1 and DS2 for communication with the chassis domain of a central control unit (M-ECU_{chassis domain}). The braking system may further comprise an e-pedal with a sensor ECU and sensors, in particular with a force-displacement sensor based on the principle of differential displacement measurement (cf. U.S. Ser. No. 13/883,192), transferred to the e-pedal concept for the detection of the pedal force. The sensor ECU can be in direct communication with the central control unit of the chassis domain.

In addition, special bidirectional inlet/outlet valves (simplified as MV₂ₖ) can be used for each wheel brake, whereby pressure can be built up or reduced by simultaneously moving the piston of a piston-cylinder unit forward and backward. Alternatively, different connections of the valves can be provided so that the cross sections of the valves can be controlled through appropriate energization either during pressure build-up or pressure reduction. If, for example, the valve seat is connected to the wheel brake, different pressure gradients can be implemented when the pressure is reduced, so that the pressure in multiple wheel brakes can be reduced simultaneously and with little noise. The pressure build-up is then carried out via a volume control by the pressure supply unit either simultaneously or in a multiplex process.

If the valve seat is connected to the pressure supply, the pressure is built up via a classic system pressure control. For the latter process, exhaust valves AV1-AV4 are advantageous but are not necessarily provided for pressure reduction. In addition, it is expedient to use the outlet valves only in extreme situations, as this results in the volume of the pressure supply to the reservoir being lost; in the case of a relatively lengthy control intervention, it is then necessary to return volume from the reservoir by retracting the piston (cf. a control strategy according to EP 2580095 B1). The volume reduction via the exhaust valves must therefore be dimensioned such that a braking process can be completed in its entirety in order to avoid a critical control interruption, and such that additional delivery only has to take place only upon completion of the braking process. Alternatively, a continuously delivering two-stroke piston can be provided for the pressure supply, as described in EP 3 145 771 B1, or the electric traction motors can take over the braking torque control during the interruption phase.

Such a system solution has the freedom of optional pressure reduction via the inlet/outlet valves MV₂ₖ or via outlet valves. The use of exhaust valves is therefore optional, and 1-4 exhaust valves can be provided. The exhaust valves only offer another degree of freedom in the pressure reduction options. It is expedient to equip all wheels with exhaust valves upon introduction of the system, although their number can be gradually reduced later as part of product maintenance.

Alternatively, the well-known multiplex method on two wheel brakes can be combined with the classic pressure control on two further wheel brakes via inlet/outlet valves. Optionally, standard inlet valves are used instead of the inlet/outlet valves, or the MV₂ₖ valves are used only for pressure build-up and pressure reduction in brake booster operation. The electric traction motors can also be advantageously used for the purpose of downsizing (see FIG. 5) in order to implement an efficient blending strategy, in which case they provide a basic braking torque in ABS mode and/or are used in the emergency braking function AEB (see FIG. 4) in order to achieve a faster TTL.

In addition, a targeted braking torque intervention is advantageously specified via the domain as a setpoint or setpoint curve, which advantageously also determines the time course of the increase or decrease in braking torque, enabling efficient synchronization with the braking torque curve of the electric traction motors to take place. The intervention can be performed on an axle-specific or wheel-specific basis. The wheel-specific intervention is primarily used for yaw moment control, for example for torque vectoring interventions, advantageously also synchronized with the steering intervention of the electric power steering EPS.

The use of MV₂ₖ valves also offers the advantage that the failure of a wheel circuit can be diagnosed and the wheel circuit can be isolated through closure of the MV₂ₖ valves in the event of a fault. This means that, even if one wheel circuit fails, 3-channel controlled operation is still possible, which can be used for ABS control but also for yaw moment interventions for steering assistance or emergency steering in the event of failure or partial failure of an electric power steering system.

In addition, the brake units are preferably designed redundantly, for example with redundant windings and electronics, so that the individual brake units can still be operated even in the event of a partial failure. This enables two to three-fold redundancy of the braking function to be achieved with high reliability. Even if braking performance is reduced, critical situations can still be controlled. If the pressure supply fails partially, 50% of the maximum braking torque is still built up with reduced dynamics of the 1×3 instead of 2×3 phases, i.e., about 70 bar with a design of 140 bar. This means that full ABS mode can be achieved on both axles up to the point of locking pressure, because the electric traction motors can then provide supporting torque on one or both axles.

The hydraulic braking system with the driving dynamics system of the present description has a very simple and cost-effective design (few solenoid valves, downsized pressure supply) and meets all redundancy requirements of SAE Level 4, as specified above.

FIG. 6b shows a second embodiment of the electrohydraulic brake unit EHB with two electric traction motors TM1 and TM2 on the rear axle and one traction motor TM3 on the front axle. The traction motor TM3 can be dispensed with, in which case both of the traction motors TM1 and TM2 are system-relevant and map the topology B of FIG. 2.

Only one hydraulic line leads from the pressure supply of the electrohydraulic brake unit EHB to the two wheel brakes RB3 and RB4 of the rear axle and, advantageously, only one cost-effective drum brake is used on the rear axle.

With more than 50 KW per wheel, the electric traction motors TM1 and TM2 are powerful. The braking torque build-up and braking torque reduction are performed dynamically. The traction motors TM1 and TM2 take over the braking torque control, while the EHB is only used to apply a basic braking torque for the rear axle in normal operation.

Controlled operation is comparable to the case shown in FIG. 5, with the difference that the roles of the EHB and the traction motors are swapped, and this time the EHB builds up the basic braking torque instead of the electric traction motors. On the front axle, however, ABS control is carried out via the EHB, and the optional TM3 traction motor provides the basic braking torque. If an optional TM3 traction motor is used on the front axle, a cost-effective drum brake can also be used here.

In the first case of a fault, for example if the hydraulic connection to the wheel brakes on the rear axle fails, the connecting line is disconnected via the shut-off valve and the traction motors completely take over the control function. This means that the rear axle deceleration may be limited due to the performance and speed of the traction motors, but all safety-critical functions (μ-jump, ABS on low-u) can be controlled very safely, and controllability (Priority 3) is ensured by the front axle pressure control and/or by controlling the EPB steering via the driving dynamics system.

It is expedient to limit the speed of the vehicle in such a fault case (for example to 75 km/h if the motor is designed according to FIG. 3). This fault case leads to a longer braking distance without a speed limit, but is otherwise not critical from a safety point of view.

If the electric traction motors TM1 and TM2 of the rear axle fail in a second fault situation, ABS is controlled axle by axle via the pressure supply system. Steering interventions are then preferably carried out via control of the EPS by the driving dynamics system. If only one traction motor fails, steering interventions can also be carried out via the traction motor that is still active.

The pressure control can be maintained even in the event of a partial failure of the pressure supply, for example in the event of a winding failure of an electric motor, albeit with lower power, by having the second string of the 2×3 phases take over the control with 50% of the power. In this case, the traction motors on the rear axle can also take over the anti-skid control (ASC) as well as torque vectoring or yaw moment interventions.

The embodiment of a hydraulic braking system according to FIG. 6b is even simpler than the system shown in FIG. 6a, since fewer solenoid valves and hydraulic lines are provided, and a drum brake can be used. The embodiment according to FIG. 6b also meets the redundancy requirements of SAE Level 4, as specified above.

FIG. 6c shows a third embodiment with two electromechanical brakes EMB1 and EMB2 on the rear axle and a traction motor TM3 on the front axle.

The traction motor TM3 can be dispensed with, but in that case the electromotive brake units EMB1 and EMB2 are system-relevant and map topology B and topology D in FIG. 2. Only one hydraulic line leads from the pressure supply of the EHB to the two wheel brakes RB3 and RB4 on the rear axle. In particular, only one cost-effective drum brake can be used on the rear axle.

The electromechanical brake units EMB 1 and EMB 2 are designed to dynamically build up and reduce braking torque and are responsible for controlling the braking torque. In normal operation, the electrohydraulic brake EHB is only used to apply a basic braking torque to the rear axle. Controlled operation is similar to that explained above with reference to FIG. 5, but with the difference that the roles of the EHB and the EMB are swapped and the EHB builds up the basic braking torque. On the front axle, however, ABS control is carried out via the EHB, and the optional TM3 traction motor provides the basic braking torque. If an optional TM3 traction motor is used on the front axle, a cost-effective drum brake can also be used here.

In the first case of a fault, for example if the hydraulic connection to the wheel brake of the rear axle fails, the connecting line is separated via the shut-off valve and EMB1 and EMB2 completely take over the control function on the individual wheels of the rear axle. This means that all safety-critical functions (μ-jump, ABS on low-μ) can be controlled very safely, and controllability (Priority 3) is ensured by the front axle pressure control and/or by controlling the EPB steering via the driving dynamics system.

The electromechanical brake units EMB1 and EMB2 are expediently designed for the locking braking torque with a small reserve for fading (20% reserve); for reasons of cost, however, the electromechanical brake units EMB1 and EMB2 can also be advantageously designed for a braking torque below the locking limit (approximately 50% of the locking braking torque). In normal operation, the EHB support enables the braking torque to be reliably achieved for controlling maximum deceleration without placing too much thermal stress on a drum brake. If the hydraulic line fails, it is perfectly acceptable that the rear axle be able to contribute less braking torque to the overall deceleration than the front axle, since the influence on the increase in braking distance is rather small. What is of primary importance is controlled operation at low-μ and μ-jump. In those cases, 50% of the locking torque is sufficient for safe vehicle operation.

If the electromechanical brake units EMB1 and EMB2 of the rear axle fail in a second fault situation, ABS is controlled axle by axle via the pressure supply system. Steering interventions are then preferably carried out via control of the EPS by the driving dynamics system. If only one electromechanical brake unit EMB (EMB1 or EMB2) fails, steering interventions can also be carried out via the electromechanical brake unit EMB (EMB2 or EMB1) that is still active.

Pressure control can be maintained even in the event of a partial failure of the pressure supply, for example in the event of a winding failure of an electric motor, albeit with lower performance, by having the second string of the 2×3 phases take over control with 50% of the torque. In addition, the electromechanical brake units EMB1 and EMB2 on the rear axle take over the anti-skid control (ASC) as well as torque vectoring and/or yaw moment interventions.

The embodiment of a hydraulic braking system according to FIG. 6c is simpler than the system shown in FIG. 6a, since fewer solenoid valves and hydraulic lines are provided, and a drum brake can be used. The embodiment according to FIG. 6c also meets the redundancy requirements of SAE Level 4, as specified above.

Such a solution is useful when no electric traction motor is provided on the rear axle or an electric traction motor is provided neither on the rear axle nor on the front axle for interventions for generating braking torque by the driving dynamics system, for example for hydrogen vehicles or hybrid vehicles, in which the electric motor is closely connected to an internal combustion motor and is therefore not dynamic.

FIG. 6d shows a fourth variant of the electrohydraulic brake unit EHB for integration into the driving dynamics system in which only one electrohydraulic brake is provided for the front axle and, as in FIG. 6b, an electric traction motor TM1 and TM2 is also provided for each wheel on the rear axle.

In contrast to the system in FIG. 6b, the rear axle is not supported by a basic braking torque via the EHB, which means that the traction motors are advantageously designed to be more powerful and can apply a braking torque up to the locking limit and also regulate it dynamically. Such a configuration is advantageous for sports cars or premium vehicles with powerful motors, since the motors are sufficiently powerful and an electrohydraulic brake unit (EHB) for the rear axle is no longer required. With such an arrangement, the friction brake on the rear axle is completely eliminated. The traction motors TM1 and TM2 perform many functions (ESP interventions, ASC interventions, ABS interventions, EBD braking torque setting) and are controlled synchronously via the driving dynamics system with the electrohydraulic brake units EHB of the front axle, i.e., the braking torque setpoints are also synchronized temporally.

FIG. 7a shows two curves of motor torque-speed characteristic maps, scaled with a gearbox ratio to the speed of a vehicle of 1,800 kg up to a maximum speed of 200 km/h, for which reason it is shown as a motor torque-vehicle speed characteristic map. The braking torques for a deceleration of 1 g=9.81 m/s² are calculated with a weight distribution VA/HA of 65%/35% and as dashed lines for the braking torques of the front axle (upper horizontal line, dash-dot) and rear axle (lower horizontal line, dashed). In a first motor torque-vehicle speed characteristic map 1 (referred to as “Mbrake_normal” in FIG. 7a), a typical design of a motor with a typical inverter is assumed, since the electric traction motor is designed for a constant power and, starting from a certain point P1, the power hyperbola is therefore primarily limited by the voltage. Up to a speed of v2, the maximum braking torque on the rear axle can be generated by the electric traction motor in generative mode.

In order to be able to optimally use the braking torque of the traction motor for braking even at maximum speed, an inverter can advantageously be used which enables the coils to be switched from a series connection to a parallel connection of coil windings. This halves the inductance, enabling a greater torque to be generated at the same speed at a given voltage; at the same time, the torque dynamics are increased by 100%, which is very advantageous for the highly dynamic braking torque control in ABS mode. In addition, in order to prevent a complete failure of the electric traction motor as a brake unit, the inverter is to be designed in such a way that, comparable to a 2×3-phase inverter concept, operation is still possible even if one or more components (power semiconductors, coil windings) fail.

In other exemplary embodiments, other topologies that are known from the prior art and having a similar effect can also be used to achieve the functionality required above. However, these usually have between 24 and over 42 switching elements in order to implement redundancy (2×3 phases) and the ability to switch between series connection and parallel connection during operation. They can also be used for the boost function.

FIG. 7b shows an inverter which, in contrast to similar systems from the prior art, requires only 18 switching elements instead of 30 to over 40 switching elements and which, like standard inverters of a brushless motor, can also be operated in 4-quadrant operation. The four quadrants result from positive or negative torque and positive or negative speed. The 4-quadrant operation, on the one hand, makes a motor torque boost operating mode possible in which the torque is temporarily increased by up to 100% and, on the other hand, provides redundancy in the event of failure of one or more components (circuit breakers, coil windings).

For the time being, due to the complexity of the circuits and components, inverters with the options described above are still more complex than a standard inverter with three phases, which typically have six switching elements. The application for the driving dynamics system described here is especially attractive if, according to FIG. 6c, exclusively regenerative braking of the rear axle can be carried out in normal braking mode and in ABS control mode and there are therefore potentially significant cost and weight savings due to the elimination of the friction brake. In addition, although the redundancy of the inverter is not absolutely necessary for SAE Level 2, the requirements for SAE Level 3 are met, because controlled operation on the rear axle is still possible even in the event of a partial failure of the electric traction motors. Alternatively, SAE Level 3 also warrants a state-of-the-art inverter concept with 30 to 40 components, because comparable braking systems-2-box braking systems, for example—are significantly more complex than typical 1-box braking systems for SAE Level 2.

The configuration of the novel inverter according to the invention (referred to as “RSP-4Q inverter”), described in detail below, makes it possible to implement an inverter with only 18 switching elements (a total of only six connection switching elements and twelve supply switching elements), making it possible to switch from a series connection to a parallel connection of the phases and vice versa during operation of the electric motor. In parallel connection, the twelve supply switching elements are active, whereas in series connection the six connecting switching elements and six of the twelve supply switching elements are active. “Active” can be understood here to mean that these switching elements are controlled in a clocked manner, while the other switching elements are in freewheel mode, for example.

In addition, switching from series connection to parallel connection or vice versa takes place as a function of the failure of one or more operating elements. In the present case, the operating elements can be understood to mean, but are not limited to, the switching elements, for example supply switching elements and connection switching elements, and/or the coils of the individual phases. This design makes it easy to continue operating the electric motor in the event of a failure of one or more operating elements by switching from series connection to parallel connection.

The inverter shown in FIG. 7b, as described in WO 2021/179980, is connected to an electric motor 4 with six phases U, V, W, U′, V′, W′ which is only shown schematically with a circle and its connections.

Each phase U, V, W, U′, V′, W′ has at least one coil 6. Two phases U, V, W, U′, V′, W′ are combined to form a string. A string is shown in FIG. 7b by way of example, the phases that form the string being circled. Each of the two phases U, V, W, U′, V′, W′ of the string 8 is electrically rotated by 180 degrees relative to the other phase U, V, W, U′, V′, W′ of the same string 8—i.e., they are connected in an inverted manner. The inverted phases U′, V′, W′ are marked with a prime in order to distinguish them from the other phases U, V, W. In the embodiment, phase U′ is the phase that is inverted relative to phase U, phase V′ is the phase that is inverted relative to phase V, and phase W′ is the phase that is inverted relative to phase W.

The inverter also has six switching units 10, which are represented by dashed rectangles. Each switching unit 10 is associated with a phase U, V, W, U′, V′, W′. In addition, the switching units 10 of the two phases U, V, W, U′, V′, W′ of a string each form a switching module. In the figure, the switching units 10 each form a switching module, so that the inverter according to the invention according to FIG. 7b has three switching modules. Each switching unit 10 is connected to a supply voltage which supplies the individual phases U, V, W, U′, V′, W′. For this purpose, each switching unit 10 has two supply switching elements 16. In the exemplary embodiment, the supply switching elements 16 are embodied as a MOSFET.

Depending on an operating mode of the electric motor 4, the two phases U, V, W, U′, V′, W′ of a string are connected in parallel or in series with each other. For this purpose, the inverter 2 has a control unit which is designed to control the supply switching elements 16 and the connection switching elements 20.

In addition, the inverter 2 has a fuse unit (not shown in FIG. 7b), which is also referred to as a “circuit breaker module” and is arranged between the electric motor 4 and the inverter 2. The fuse unit has switching elements (not shown) which are designed to preferably galvanically isolate the electric motor 4 from the inverter 2 in the event of a fault.

Due to its simplicity, the RSP-4Q inverter described here is used for the torque boost control strategy as described in FIG. 7a. In other exemplary embodiments, however, other inverters may also be suitable which enable switching of the inductances during operation, such as an inverter with switching between delta and star connection or another inverter such as those used, for example, in DE 11 2018 000 733 T5 or DE 11 2018 001 213 T.

FIG. 8 shows an advantageous embodiment of a normally open bidirectional inlet-outlet valve MV₂ₖ, which is used for implementing the pressure control functions in the EHB braking systems of FIGS. 6a to 6d or for an axle pressure adjuster according to FIGS. 9a and 9b.

FIG. 8 shows a special valve MV₂ₖ which is required for the abovementioned embodiments and functions reliably in both flow directions. This means that the functionality of the valve is guaranteed, even with high flow rates, such as 100 cm³/s-120 cm³/s, or large pressure differences across the valve, such as 160 bar-220 bar. In particular, for the parameter ranges described above, this MV₂ₖ valve ensures that it does not close automatically.

The MV₂ₖ valve basically has the typical construction of a solenoid valve with electromagnetic circuit EM1 with an armature 6, a valve actuator or valve tappet 7, and a valve seat 8 as well as a return spring 13. The return spring can be dispensed with if the additional force device, which in FIG. 8 is formed by an electromagnetic circuit EM2, is designed accordingly.

The magnetic circuit EM1 generates (see FIG. 8a) a strong progressive force curve FM1 over a stroke h and the return spring 13 generates a progressive restoring force FRF over the stroke h to reset the armature.

In the left part of FIG. 8, the armature 6 is coupled to a second force-generating element, which forms an additional force device. This may consist of a second electromagnetic circuit EM2 with armature 6a, whose switchable force FM2 counteracts the force FM1 of the first magnetic circuit EM1.

As a more cost-effective variant, a permanent magnetic circuit comprising a small permanent magnet 9 with pole plate 10 can also be used as a passive additional force device.

The force effect of FM2 counteracts FM1 and acts with a relatively strong force when the valve is open with a strong desired drop in force over the stroke h.

When the end of the stroke is reached, the force F_{M2} (see FIG. 8b) is still great enough to take over the usual armature return and can therefore optionally replace the usual return spring 13.

FIG. 8c shows the interaction of the force sources F_{M1} as a function of the current intensity and F_{M2} for the permanent magnet.

In the closed valve position, the pressure difference P2-P1 acts on the valve seat with the force FP, which is directed toward the valve opening if the pressure P2 is greater than the pressure P1.

In the open valve position, the volume flow Q through the valve exerts the described hydraulic force F_{H} on the valve seat, which could cause the valve to close without countermeasures, both during pressure build-up Pup and during pressure reduction P_{down}, depending on how the solenoid valve MV₂ₖ is connected to a pressure supply DV and a wheel brake cylinder RZ, and depending on the direction in which the volume flow is. This is the basis for the pressure control with pressure supply device and wheel brakes shown in the following FIGS. 9a and 9b.

If the solenoid valve is in an open position, a force FH, which is dependent on the level of the volume flow Q due to the Bernoulli effect, is exerted during flow through the valve, starting from the valve armature connection (14) in the direction of the valve seat connection (16). If the volume flow Q is very high, for example with high pressure differences, this can lead to the valve being closed by the flow force FH alone. As a result, the valve closes and can no longer be opened.

To avoid this effect, the force of the additional force device F_{M2} counteracts the force F_{H} and prevents the valve from closing even in the event of large pressure differences that can occur during braking system operation.

Preferably, the additional force FM is at its greatest when the valve is in the open position, which can be achieved, for example, by a permanent magnet circuit, and acts over the entire stroke range and supports the restoring force of the valve spring F_{RF} in such a way that the valve is always returned to the open valve position when a volume flow Q flows through it, regardless of the valve position—i.e., particularly even in a half-closed state.

The valve return spring 13 can also be omitted through appropriate design.

The valve must also be designed in such a way that, when the valve is energized by activating the magnetic circuit EM1, the primary valve force FM1 is able to overcome the sum of both forces (F_{M2}+F_{RF}) so that the valve can close when energized.

Large volume flows can occur, for example, when the wheel brake is connected to the switching valve via the armature connection, as is typically the case with a wheel valve configuration with inlet/outlet valves (see FIGS. 6a-6d for this embodiment), and the ECU or power supply of the braking system fails at this time, thus preventing pressure reduction via outlet valves, because these are closed by the differential pressure and can no longer be opened because a remaining residual pressure greater than the restoring force FRF of the valve spring keeps the valve closed. Valve closure can also occur when the pressure of the wheel brake is reduced with a very high pressure gradient, for example when the pressure is reduced by a very rapid return movement of the piston of the pressure supply unit.

A normally open valve design is also relevant when the pressure supply device is connected to the armature connection (see FIGS. 9a and 9b, for example), and pressure is built up very quickly with the pressure supply unit. A rapid pressure build-up occurs, for example, with the automatic emergency brake (AEB) or with the multiplex process with pressure curve control via volume control/control of the pressure supply device instead of system pressure control as well as pressure curve control via volume flow throttle control of the PWM control of the inlet valves.

The closing effect can be limited by a pressure difference limitation in the control of the pressure supply unit or preferably by means of a throttle which is not shown in the figures, the throttle being installed in a hydraulic line upstream from the armature connection of the valve connection.

In addition, it is alternatively conceivable for a pressure relief valve to be arranged in a hydraulic parallel circuit to the switching valve which opens at high differential pressures and thus limits the hydraulic force F_{H} effective due to the Bernoulli effect and therefore does not require the additional force device F_{M2}. This simplifies the valve design but limits the pressure change dynamics via the hydraulic pressure supply.

Such measures are not necessary if the braking torque change is controlled in parallel via a traction motor, because the demands placed on the dynamics of the hydraulic braking system are lower. Standard valves can then be used without additional power devices and without a throttle or pressure relief valve.

In the event of a wheel circuit failure, a wheel circuit can be isolated by closing an inlet valve SV which is arranged between the wheel brake and the pressure supply. The hydraulic braking system with n-wheel circuits can then be operated with one fewer wheel circuit—i.e., with n−1 wheel circuits. For example, 3 circuits can be used instead of a 4-circuit braking system control. This means that, in the event of a wheel circuit failure after the inlet valve SV is closed, a very high level of deceleration can still be achieved, and yaw moment control with 3 wheel brakes or an ESP function can also be maintained. If an electric motor is available on the failed wheel circuit, it can take over the braking torque control of the failed wheel brake, enabling a 4-circuit braking torque control to be maintained with no or only minor restrictions, for example due to the maximum braking torque of the traction motor.

The valve tappet 7 can also have a special shape which provides the counterforce through hydraulic flow forces and can reduce the closing force.

FIG. 8c shows the electrical control of the valve via a current i. The current intensity i1 in the closed valve position is selected such that F_{M1} is greater than F_{M2}. The current can then be varied in the closed position of the valve, at current intensity i2, as a function of the hydraulic differential pressure P2-P1 across the valve. Since the force F_{M2} in this position is in the range of the usual spring force for the reasons described, the valve can also be operated, for example, using a current control or current regulation.

In order to keep the valve in the closed position, the differential force

$${F}_{V , closed} = {F}_{M 1 , c l o s e d} - {F}_{M 2 , closed}$$

must be greater than the force FP resulting from the differential pressure P2-P1 across the valve in the closed position.

FIG. 9a describes the construction of a pressure actuator in the form of a piston-cylinder unit driven by an electric motor via a gearbox to which two wheel brakes R1 and R2 and, optionally, additional hydraulic consumers Vx are connected via hydraulic lines. Additional hydraulic consumers Vx can be additional wheel brakes or other hydraulic consumers, for example hydraulic pistons of a clutch or clutches or hydraulic power steering or other actuating pistons of a vehicle axle. Preferably, the pressure actuator is also connected to a valve device with a reservoir VB.

The pressure actuator preferably has 2×3-phase connections to two control units ECU1_{EHB} and ECU2_{EHB}, with current sensors i/U and angle sensors a/U are provided, which are preferably also redundant and which are used for high-precision PPC pressure control or pressure control via piston position or current.

A pressure sensor p/U, which is primarily used for calibration purposes, is preferably provided at the output of the pressure supply. However, the pressure regulation or pressure control can also be carried out without this pressure sensor if the connection between the EHB braking torque and the current or piston position is established in another way, for example by using acceleration sensors or a compensation with the braking torques or the vehicle deceleration by means of braking torques of the electric traction motors TM1-TM4.

Bidirectional inlet/outlet valves, referred to here as “MV₂ₖ,” are used as solenoid valves. The MV₂ₖ valves are operated in such a way that pressure can be built up and pressure reduced via the solenoid valves, whereby the pressure change occurs in a particularly highly dynamic manner, i.e., at >1000 bar/see, preferably >2000 bar/sec. The valves must be designed to be normally open in accordance with the system specification, i.e., in accordance with the required maximum pressures and maximum volume flows.

Preferably, solenoid valves with a first soft iron magnetic circuit EM1 and a second permanent magnet circuit EM2 according to FIGS. 8-8c are used.

Alternatively, modified inlet valves of a standard ESP unit can be used as MV₂ₖ, i.e., normally open solenoid valves with a standard valve opening cross section and 6 mm magnet armature diameter without a second permanent magnet circuit EM2, which can also be designed to be normally open in the classic design, in particular due to the lower maximum pressures occurring in the present driving dynamics system and the resulting lower closing forces in the event of a pressure change with maximum pressure gradients.

If inlet valves of an ABS/ESP unit are used as MV₂ₖ valves, they must be designed according to the pressure differences and pressure change rates, for example with a stronger magnetic circuit with a larger armature and/or stronger return springs.

Alternatively, the pressure gradient and/or pressure differences can be limited by controlling the pressure build-up via software, so that a dynamic pressure build-up does not lead to the solenoid valves closing.

Due to the fact that the pressure range for the control of the driving dynamics system described here is lower than for standard braking systems, and because a braking torque can also be built up via the electric traction motor, the requirements for the MV_{2K} valves are lower than for standard braking systems.

What is specific to the MV₂ₖ valve—regardless of the variant selected—is that the solenoid valves are designed without a parallel-connected check valve, or no check valve is arranged in parallel in the hydraulic line in the hydraulic connection between a wheel brake R1, R2 or a hydraulic consumer Vx and the pressure supply device.

The purpose of this is to keep the pressure in one wheel brake constant while the pressure in other wheel brakes is changed. This constitutes a major difference from standard braking systems, in which pressure in a wheel brake can only be maintained via a system pressure by the pressure actuator; this severely limits the degrees of freedom in pressure control in standard braking systems and also makes diagnosing a wheel brake failure considerably more difficult, if not impossible, since in the event of a wheel circuit failure it is not possible to determine whether the solenoid valve, the check valve, or the hydraulic power is the cause.

If an MV₂ₖ valve is used, the wheel brake can be reliably isolated from the pressure supply regardless of the cause of the failure. It is therefore possible to switch from an m-circuit electrohydraulic braking system EHB to an m−1-circuit braking system. In FIG. 9a, for example, a 2-circuit EHB with two wheel brakes becomes a 1-circuit EHB, or a 3-circuit EHB with Vx becomes a 2-circuit EHB.

In the case shown in FIG. 6a, a 4-circuit EHB becomes a 3-circuit EHB, and in FIG. 6b, a 3-circuit EHB becomes a 2-circuit EHB.

A special feature of this first configuration is that the valve seat of the MV₂ₖ valve is connected to the wheel circuit and that its armature chamber is connected to the pressure actuator.

Such a design makes it possible to implement an innovative pressure control with bidirectionally acting inlet/outlet valves as well as forward and backward movement of the piston of a piston-cylinder unit via current or piston control as well as simultaneous pressure gradient-controlled pressure reduction. In one embodiment, the pressure build-up takes place sequentially using the well-known multiplexing process. Alternatively, the dead time of pressure build-up due to a braking torque gradient can be avoided by an electric traction motor, which is possible if an electric traction motor for wheel-specific drive is available. Alternatively, the braking torque can also be built up via the traction motor of only one axle, which is possible particularly if both wheels on one axle have the same increase in braking torque.

If a simultaneous pressure build-up is required and no electric traction motor is available to assist, the pressure build-up can also be carried out simultaneously by timing the valves, meaning that a variable system pressure is set by the piston and one valve is closed earlier than the second valve. The pressure reduction takes place simultaneously on multiple wheel brakes via piston control using the pressure volume characteristic curve as well as PWM control of the valves or current control of the valves. This means that a variable flow cross section is set via a current, enabling different pressure reduction gradients to be implemented.

Such a control is referred to as PPC-Gen2-V1 (first-generation Piston Pressure Control with valve connection V1): valve seat inlet/outlet valve MV₂ₖ on wheel brake).

FIG. 9b describes the construction of a pressure actuator with a piston-cylinder unit driven by an electric motor via a gearbox with MV₂ₖ switching valves, whose valve seat, unlike in FIG. 9a, is connected to the hydraulic line to the pressure actuator and whose armature chamber is connected to the wheel brake. Optional exhaust valves are also available.

With such a construction, a second variant of a pressure control PPC-Gen1-V2 can be implemented with bidirectionally acting inlet/outlet valves MV₂ₖ as well as forward and backward movement of the piston of a piston-cylinder unit via current or piston control as well as simultaneous pressure gradient-controlled pressure build-up. The valve design of the MV₂ₖ valves is similar to the configuration shown in FIG. 9a and is therefore transferable, as is the PPC pressure regulation or pressure control as well as the preferably redundant design of the motors with redundant electronics ECU1_{EHB}, ECU2_{EHB} and sensors a/U, i/U.

In one embodiment, the pressure reduction takes place successively using the known multiplex process with a time delay Δt_{MUX} or via a time control of exhaust valves, as known from classic ABS systems.

In contrast to the prior art, the pressure reduction can also take place simultaneously in one wheel circuit (R2) via inlet/outlet valves by means of piston control based on the pressure-volume characteristic curve, while it takes place via outlet valves in a second wheel circuit (R1′). This enables the time delay Δt_{MUX} to be avoided.

This makes it possible for the pressure to be released very quickly in critical driving situations, such as in the case of high-μ or a μ-jump. In another control state, for example at low-μ—i.e., when controlling on ice and snow—the control can be carried out using the well-known multiplex method. By combining the pressure reduction processes, very short braking distances can be achieved in all driving situations.

The combination of pressure reduction via outlet valves with inlet/outlet valves has the further advantage that no MV₂ₖ valves need be used which are designed for high pressure differences and volume flows, because during pressure reduction the MV₂ₖ valves do not have to be flowed through at high flow rates, since pressure reductions with high pressure gradients take place via outlet valves.

Furthermore, the MV₂ₖ valves are subjected to less stress during pressure reduction, because the electrohydraulic brake unit EHB described for the driving dynamics system is designed for a maximum pressure of 140 bar, and the valves do not have to be pressure-resistant for 160 bar-220 bar, as shown in FIG. 8a. This means that, in this embodiment, modified standard inlet valves of an ESP unit with typical valve opening cross sections—but without parallel-connected check valves—can be used. The advantages of not using parallel check valves were described above with reference to FIG. 9a and apply analogously to FIG. 9b.

By virtue of the advantageous combination with exhaust valves, the pressure can be reduced quickly in all driving situations, which also substantially reduces the demands on the dynamics of the pressure actuator's drive motor. If the MUX method is used for control in most operating conditions, the hydraulic brake circuit can be operated primarily in the closed brake circuit. This means that the critical additional supply of hydraulic fluid during controlled operation—typical for open systems according to the prior art (DE 10 2018 212 905 A1), which are controlled according to the method described in EP 2 580 095 B1—can be dispensed with. The replenishment of volume in open systems is increasingly regarded as critical, since a time interruption of more than 100 ms can lead to critical driving situations.

In addition, a braking system that is embedded in the driving dynamics system described here can take on more functions in addition to pure ABS control mode—for instance, additional braking torque interventions such as torque vectoring interventions. This could cause hydraulic volume to be lost in the open circuit.

If the MV_{2K} valve according to the invention is also used as a switching valve, a wheel circuit failure can also be diagnosed analogously to the case described with reference to FIG. 9a, and the wheel circuit can continue to operate even with a small amount of leakage, which is not possible in systems according to the prior art with parallel-connected check valves.

Such a control is referred to here as PPC-Gen2-V2 (second-generation Piston Pressure Control with valve connection V2): valve seat inlet/outlet valve MV₂ₖ on pressure supply).

As an alternative to the normally open solenoid valves MV₂ₖ, standard inlet valves of an ABS/ESP unit can also be used which are designed in accordance with the pressure differences and pressure change rates, for example with a stronger magnetic circuit and/or stronger return springs. Due to the fact that the pressure range of the driving dynamics system control described herein is smaller than that of standard braking systems, the requirements for the solenoid valves are lower.

As an alternative to the piston-cylinder unit with inlet/outlet valves, a simple pump can also be used, for example a 2-piston pump according to the prior art for ABS pumps, or a gear pump according to WO 2021 005 151 A1. In the case of a 2-piston pump, the pressure reduction is controlled via outlet valves, and the pressure build-up is controlled via a system pressure and a PWM control of the inlet valves. If a gear pump is used, the same degree of freedom exists as with the piston-cylinder unit, because pressure can be applied either via outlet valves or via the gear pump by changing the direction of rotation. This design has cost advantages but disadvantages in terms of the precision of the braking torque control due to leaks in the gear pump.

FIG. 10 shows the advantageous “Architecture II” of the driving dynamics system for electric axles, with multiple brake units acting on the front axle and rear axle.

Brake units are traction motors TM1, TM2, TM3, hydraulic pressure actuators EHB HA, EHB_{VA}, and/or EMB modules for wheel brakes. The central control unit controls the braking torques and sends target signals to the control units S-ECU_{VA} and S-ECU_{HA} of the axles. Analogously to “Architecture I,” the following functions are preferably implemented:
(A) basic brake with thermal management and energy flow management of the traction motor;
(B) emergency brake AEB with electronic brakeforce distribution (EBD);
(C) regenerative braking on multiple axles;
(D) ABS control with basic brake torque assistance and/or common brake torque control;
(E) braking operation in the event of failure of the electrohydraulic brake unit EHB-Z, EHB-VA;
(F) yaw moment interventions or wheel-specific braking torque interventions; and/or
(G) wheel-specific braking torque interventions for wheel-specific regenerative braking.

The driving dynamics system sends target values, particularly braking torques or braking pressures. For certain functions (such as functions (C), (F), (G) described above), target signals for pressure control or pressure regulation are also specified, for example control signals for solenoid valves for functions such as the switching duration of the opening time, PWM frequency, or alternatively the current profile in the event of a pressure change with throttled valve cross sections, and/or system pressures for the pressure supply device for pressure build-up or pressure reduction.

Furthermore, the M-ECU_{domain} can also have an interface to the control unit or domain of autonomous driving M-ECU_{AD} and can evaluate further information that is helpful for effective and predictive control. This includes, for example, camera information about the condition of the roadway (snow, ice, rain) or information about the surroundings (distances to pedestrians and/or other vehicles).

A first embodiment of an axle module will now be described with reference to FIG. 11a. In this example, electromotive brake units EMB1, EMB2 are provided on each wheel, and an electric traction motor TM1 is provided for the axle.

A control unit of the S-ECU axle communicates with the electromotive brake units EMB1, EMB2 and the electric traction motor TM1 and sends corresponding target signals in such a way that a braking torque is preferably controlled simultaneously by means of the electromotive brake units EMB1, EMB2 and the traction motor TM1. In this case, the braking torques preferably act additively on the wheels, even in control mode.

For example, the traction motor TM1 is preferably used to build up a basic braking torque that reduces the braking torque amplitude of the EMB modules (see above description with reference to FIG. 5). In addition, the basic braking torque of the traction motor TM1 can also be reduced at the same time as the EMB braking torques of the wheel brakes, which enables greater braking torque gradients to be achieved. This is especially important in critical driving situations such as a μ-jump (see above description of control situations with reference to FIG. 5b). This can also be advantageously used for downsizing the EMB modules with low maximum forces and lower power of the EMB drive motors.

Another embodiment will now be described with reference to FIG. 11b. An electrohydraulic pressure actuator EHB is combined with EMB modules in an axle module, the pressure being is preferably constructed according to FIGS. 9a and 9b and enabling wheel-specific control.

This means that individual wheel control can be achieved either by the EMB modules or by means of the electrohydraulic brake unit EHB.

This allows for maximum degrees of freedom in pressure control.

It also makes redundancies possible in the wheel-specific pressure control, as required for SAE Level 4-5, for example, so that the ABS control function can be implemented redundantly and with two different designs of the brake torque controller. This is especially advantageous in terms of meeting redundancy requirements.

Such a configuration is designed especially for the front axle of an autonomously driving vehicle, where more stringent requirements must be met than for the rear axle, for example with regard to controllability and the major influence on the braking distance.

Such an axle configuration can also be used to simplify steer-by-wire systems, which typically have two steering actuators, with one steering actuator also being equipped with a 2×3 phase winding. The braking torques can simplify steering, because reliable, redundant steering can be ensured by braking torques. This leads to cost savings of up to 100 € in steering.

Alternatively, a pressure actuator with only one hydraulic line on two wheel brakes is also conceivable, although this is not shown in FIG. 11b. As an alternative to a piston-cylinder unit, a simple rotary pump in the form of a gear pump by means of which pressure can be built up and pressure reduced is also conceivable. In this embodiment, an axle-wise braking torque can be applied. The hydraulic pressure actuator then acts in a similar manner to the traction motor in the control system, but it can also achieve deceleration up to locking pressure due to the lack of power limitation. This makes an axle-wise ABS function possible, which is absolutely sufficient for controlling a rear axle if individual wheel control is implemented on the front axle.

If the system of FIG. 11b is provided for the rear axle and combined with a system of FIG. 11a for the front axle, a 3-channel ABS mode and a yaw moment control can be implemented.

Another embodiment with an electrohydraulic brake unit EHB and two electric traction motors TM1 and TM2 will now be explained with reference to FIG. 11c. One traction motor is provided for each wheel.

Alternatively, the electrohydraulic brake unit EHB is designed for individual wheel control as shown, but the electrohydraulic brake unit EHB can also be designed with only one circuit.

With such a configuration, a rear axle of a vehicle is expediently equipped and the electrohydraulic brake unit EHB is used for redundancy purposes for ABS and yaw moment control for stability interventions and steering interventions. ABS is controlled by the traction motors at low-μ and supported by EHB, while at high-μ ABS is controlled via the EHB and is supported by traction motors. The anti-skid control is carried out exclusively via the traction motors TM1 and TM2. It is expedient to equip such an axle with a cost-effective drum brake.

With reference to FIG. 11d, another embodiment will now be explained in which a traction motor TM1 is combined with an electrohydraulic brake unit EHB. The variant is comparable to the embodiment shown in FIG. 11a, with the difference that the electromotive brake unit EMB is replaced in its function by an electrohydraulic brake unit EHB.

FIG. 12 shows the maximum braking torque gradients as a function of the vehicle deceleration using exemplary designs of the typical brake unit 1 box (curve 1210), ESP standard with reservoir (curve 1220), electric traction motor (curve 1240), electric traction motor with RSP-4Q inverter (curve 1250), and pressure actuator with PPC-2Gen-V1 or V2 pressure control (curve 1260) with design for high braking torque gradients, preferably with a normally closed MV₂ₖ valve, for an exemplary maximum speed of 200 km/h.

In addition, the corresponding curve for “MUX 2.0” is shown (curve 1230), where MUX 2.0 summarizes the second-generation multiplexing methods, such as the pressure controls PPC-Gen2-V1 and PPC-Gen1-V2, which are described in the present description (see description with reference to FIGS. 9a and 9b). In these systems, normally open valves are used in particular, and a distinction is made between different valve connections and pressure control methods. With PPC-Gen2-V1 the valve seat is connected to the wheel brake; with PPC-Gen2-V2 the valve seat is connected to the pressure supply unit. In both processes, the flow through the valves is bidirectional, and the pressure is changed in one pressure change direction via volume control; in another pressure change direction, the pressure is optionally throttled by means of the opening cross section control of the valves or the valve is only changed via time control. These second-generation multiplexing methods differ from first-generation multiplexing methods (MUX 1.0) in that in the MUX 1.0 method the pressure is changed in both pressure change directions exclusively via volume control/volume regulation. In addition, pressure reduction is implemented via at least one outlet valve on a wheel brake. This leads to greater pressure change gradients than when using 1-box and ESP.

In addition, three Ranges I-III are defined:

In Range I, involving lesser decelerations, the electromotive brake unit EMB and electric traction motors, by their nature, can achieve particularly high braking torque gradients. A standard ESP system with reservoir has the lowest gradients, because there is back pressure in the reservoir, whereas 1-box braking systems reduce the pressure in the reservoir and therefore have advantages. In Range I, which is typically relevant for ABS control on snow and ice or deceleration in normal ACC braking operation, electromotive brake units (EMB) or traction motors are therefore preferably used for braking torque control.

In Range III, on the other hand, involving sizeable decelerations, electrohydraulic systems (pressure actuators with preferably PPC Gen2 control, 1-box) have the greatest advantages and preferably take over the ABS control.

In the intermediate Range II, sufficient braking torque gradients can be achieved with all of the abovementioned brake units. Preferably, a first brake torque adjuster with a low brake torque gradient then supports the ABS control with a constant brake torque, while the ABS control is taken over by a more dynamic pressure adjuster.

If the additive braking torques are linearized over the entire deceleration range by adding the braking torque gradients of two braking torque controllers each, a high braking torque gradient can be ensured over the entire deceleration range. Ideally, the preferred characteristic is expediently used to downsize the brake units: For example, motors with low drive torques and power can be used for EMB and EHB, and/or smaller control valves can be used. A cost-effective EHB pressure actuator with a trapezoidal spindle can be implemented in such a case which is only suitable for lower pressure ranges due to the spindle load caused by higher pressures.

If a pressure actuator is operated sequentially with a MUX control, dead times in the control cycles can be reduced by braking torque interventions from other units, so that a MUX control becomes relevant again, which has lost importance due to the disadvantages in extreme situations (e.g., in high-u). This has the special advantage that a braking system is then completely closed and the control can be mapped using mathematical models. This means that no complex pressure estimation models and application work are necessary, as is the case for the calibration of open ABS systems. This also makes automated application possible.

With reference to FIG. 12a, it is described for the sake of example how the target braking torques for the wheel brakes of the front axle of the vehicle are obtained from the control units. For example, a vehicle model implemented in the central control unit M-ECU_{chassis control} includes modeling data on weight distribution, a coefficient of friction of the roadway, a tire condition, and a braking pressure effect on the deceleration of the vehicle. In particular, the following values are transferred to a control unit M-ECU_{VA} of the front axle: Setpoint values for the set braking torque of the right M_{target,VR} and left front wheel M_{target,VL}, a speed of the vehicle V_{vehicle}, a speed of the right v_{frontR} and left v_{frontL} front wheel, a differential torque of the right ΔM_{target,frontR} and left front wheel ΔM_{target,frontL}, as well as a coefficient of friction of the roadway.

In particular, the control unit M-ECU_{front axle} of the front axle stores an Mn characteristic map of the traction motor TM, which indicates a dependency of the deceleration achieved by the traction motor on the speed of the vehicle or the speed of the traction motor, as well as a further characteristic map that indicates the relationship between the achievable braking torque gradient and a deceleration of the vehicle for the available brake units or the traction motor.

Based on this data, the control unit M-ECU_{front axle} determines target torques for a first M_{target,TM1} and second traction motor M_{target,TM2} of the front axle, target torques for electromechanical brake units of the first M_{target,EMB,R1} and second wheel M_{target,EMB,R2}, as well as target torques for electrohydraulic brake units for the first M_{target,EHB,R1} and second wheel M_{target,EHB,R2}. The procedure is adapted to which brake units are actually available.

These values then result in a target braking torque for the right M_{target,brake,frontR} and left front wheels M_{target,brake,frontL}.

The same procedure can be carried out analogously for the rear axle or for all wheels of the vehicle.

With reference to FIG. 13, an advantageous “Architecture III” of the driving dynamics system for wheel modules will now be explained in which two brake units act on each wheel. Traction motors TM1, TM2, TM3, TM4 and electromotive brake units EMB modules EMB1, EMB2, EMB3, EMB4 for wheel brakes can be used as brake units, for instance.

The central control unit regulates the braking torques and sends target signals to the control units S-ECU_{wheel1}, S-ECU_{wheel2}, S-ECU_{wheel3}, S-ECU_{wheel4} of the individual wheels or axles.

Analogously to Architecture I and II, the following functions are preferably implemented:
(A) basic brake with thermal management and energy flow management of the traction motor;
(B) emergency brake AEB with electronic brakeforce distribution (EBD);
(C) regenerative braking on multiple axles;
(D) ABS control with basic brake torque assistance and/or joint brake torque control;
(E) braking operation in the event of failure of an electromotive brake unit EHB-Z, EHB-VA;
(F) yaw moment interventions or wheel-specific braking torque interventions; and/or
(G) wheel-specific braking torque interventions for wheel-specific regenerative braking.

When implementing the functions, the braking torque is divided between the electric traction motor and the EMB according to characteristic maps, in particular the braking torque gradients, as shown in FIG. 12, depending on the deceleration of the vehicle. In contrast to the other architectures, the braking torque modulation is preferably carried out in all driving conditions by the electromotive brake units EMB, and only a basic braking torque is provided via the electric traction motor of the respective wheel, which is exploited in particular for the purpose of downsizing the electromotive brake units EMB. This is preferably exploited more intensively when the wheel brake is heated. If one brake unit fails, controlled operation is then taken over by the other brake unit, possibly with restrictions on the maximum achievable deceleration, but with fully redundant control functions on all wheels.

An embodiment of this architecture will now be explained with reference to FIG. 13a. In a wheel module, an electromechanical brake EMB (EMB1-EMB4) is combined with an electric traction motor (TM1-TM4), so that each wheel module forms an assembly and is controlled via a wheel module control unit (M-ECU-wheel1-M-ECU-wheel4). The respective wheel module control unit synchronizes the torque control of the electric traction motor in time and distributes the braking torque differently between the EMB and traction motor TM as a function of the driving situation, such as coefficient of friction or speed.

Preferably, the traction motor and the EMB each have an additional control unit (ECU-EMB, ECU-TM) which, in particular, contains the output stages of the inverter and the motor control and operates with a faster cycle time, while the decision heuristics and characteristic maps are preferably mapped in the wheel module control unit M-ECU-wheel.

The module control units (M-ECU-Rad1 to M-ECU-Rad4) also communicate with the central control unit (M-ECU-domain), where in particular wheel speeds v_{R1}-v_{R4} and in particular other sensor signals S1, S2, Si are read in.

It is conceivable for the wheel module control units (ECU-wheel1 to M-ECU-wheel4) to also acquire wheel speeds v_{R1}-v_{R4} as well as sensor signals S1, S2, Si. They can also perform functions of the central control unit (M-ECU-domain) redundantly.

This means that individual wheel control can be carried out either by the EMB modules or the traction motor. This allows for maximum degrees of freedom in pressure control but also redundancies in the wheel-specific pressure control, as is required for SAE Level 4-5, for example. In particular, an ABS control function can be implemented redundantly and also with two different designs of the braking torque controller, which is especially advantageous with regard to fulfilling the redundancy requirements. If one wheel module fails, a very safe and reliable control system with short braking distances and yaw moment control options can still be achieved with three wheel modules. If either the electromotive brake unit EMB or the traction motor fails within a wheel module, the other component that has not failed takes over control of the braking process.

There are different variants of the design.
a) The electromotive brake unit EMB is designed to achieve the locking pressure so that if the traction motor fails, braking can still be carried out with maximum deceleration via the electromotive brake unit EMB; however, the generous reserve for fading (typically 100%) is omitted, i.e., the electromotive brake unit EMB has only a small reserve in addition to the maximum braking torque without heating, for example 20-40%.
b) The electromotive brake unit EMB and the electric traction motor TM are designed such that the maximum deceleration is achieved in combination of the braking torques of EMB and TM, and the friction brake is designed according to the maximum braking torque of the electromechanical brake unit EMB. In addition, as explained above with regard to “Architecture I,” suitable precautions and control strategies are required in order to ensure that braking via the regenerative braking torque of the traction motor does not result in damage to the battery, especially when the battery is fully charged. The strategies to be mentioned here are (1) feeding energy back into the battery up to the limit of power consumption, (2) field-oriented control (Id/Iq current control) of the electric motor in such a way that the energy in the motor is dissipated internally, (3) otherwise dissipating the energy generated by the electric traction motor in generative mode, or (4) using an electrical temporary buffer store designed for pulse power, for example a super-cap.

Variant b) is the preferred design, because it offers the greatest potential for cost and weight reduction. However, in an initial introduction scenario of the technology, variant a) may be expedient in terms of risk minimization.

The two variants a) and b) mentioned above offer sufficient safety for SAE Level 5, because if one component of the wheel module fails or if the entire wheel module fails, the vehicle can still be decelerated with high vehicle stability and even ABS mode. There is only a reduction in braking distance at high speeds and decelerations.

The systems described herein, in particular the driving dynamics system, the vehicle, and the method, enable great cost savings to be achieved in the core components of the vehicle's braking and steering. In addition, substantial weight reductions can be achieved which, in turn, leads to further cost savings.

By optimally exploiting the potential of regenerative braking using the electric traction motor or electric traction motors, dissipative braking systems can be made smaller, because they need only provide a smaller portion of the total braking torque. The problem of fading caused by excessive heating of the friction brake can thus also be reduced.

### A: AD Level 2

If, for example, as described above for the DDS variant A1, the basic braking function (function a) is optimized with a driving dynamics system and central control as well as a blending strategy according to FIG. 3—i.e., 51% of the braking is regenerative via the traction motor on the front axle and 71% on the rear axle, for example—then the heating of the wheel brake can be minimized.

This has two positive effects on costs: On the one hand, the braking system can be designed for lower pressure, which reduces the costs of the electrohydraulic brake unit EHB, and on the other hand, the foundation brake can be make substantially smaller. This can be achieved, for example, by using smaller brake discs, smaller brake shoes, and also more cost-effective materials. This means that a cost-effective drum brake can be used on both the front and rear axles.

In a DDS variant A2, for example, in order to simplify the electrohydraulic braking system according to FIG. 6b, the traction motor on the rear axle can be designed in such a way that a torque can be generated for each wheel, either by means of a traction motor with a torque vectoring module or preferably by dividing the power of a 130 KW motor into two electric traction motors TM1, TM2, each with 65 kW. The latter embodiment with two motors is advantageous because dynamic braking torques on both wheels can be varied independently of each other.

In addition, if, as explained above, a braking torque is synchronously controlled via the driving dynamics system via the electric traction motor and the electrohydraulic brake module EHB, with one brake unit in particular providing a basic braking torque while the second brake unit provides an additional controlled braking torque (control strategy according to FIG. 5), the costs and weight of the system can be further reduced substantially.

On the one hand, the costs for the electrohydraulic brake unit EHB, in particular according to the embodiment of FIG. 6a, can be reduced through fewer and more cost-effective valves and even lower maximum pressures and volumes. This means that a cost-effective trapezoidal spindle can be used instead of a ball screw drive. It is also possible to use a drum brake on both the front and rear axles.

In a DDS variant A3, for example, in a third optimization step, only a twin traction drive (TM1, TM2) with 230 kW output, for example, can be used on the rear axle. If the RSP-4Q inverter described herein is also used according to FIG. 7b, the operating range of the regenerative braking according to the motor characteristic map in FIG. 7a can be significantly further extended again.

This means that the rear axle can be decelerated exclusively via the electric traction motor for the entire vehicle speed range up to the maximum speed. If the control function described herein is carried out via the electric traction motors TM1 and TM2, the foundation brake on the rear axle can be completely dispensed with.

In addition, no hydraulic lines to the rear axle and no control valve are required, so that the electrohydraulic brake unit EHB only has to be designed for the front axle of the vehicle (see FIG. 6c). A cost-effective trapezoidal thread can also be used.

### B: AD Level 3-4

If an electrohydraulic braking system as shown in FIG. 8 is used in a variant B1 of the driving dynamics system with a 2-box system (e.g., X-Boost3 and ESP) and integrated into the driving dynamics system as described, the redundancy requirements of SAE Level 4 can be met and the electrohydraulic brake unit EHB can be made more cost-effective through downsizing.

Furthermore, the friction brake can be reduced in terms of cost and weight even in the basic braking function (a) by providing braking assistance via electric traction motors. In particular, costs can be reduced even further by using a cost-effective disc brake on the front axle and a drum brake on the rear axle.

If an electrohydraulic braking system as shown in FIG. 6a is used in a variant B2 of the driving dynamics system with a central EHB-Z and the traction motors on both axles are used for support in accordance with the control of the driving dynamics system described herein with the basic brake and control function, then a functional redundancy level for AD Level 3-4 can be achieved with the additional redundancy functions described above, as described in the foregoing with reference to FIG. 6a, and with a redundant design of the pressure supply device. It is also assumed here that the hydraulic braking system has 4 circuits and can still be operated with 3 circuits in the event of a failure.

### C: AD Level 5

For a variant C1 of the driving dynamics system with an electromechanical brake unit EMB, the third embodiment explained above is used, where a control ECU (S-ECU_{wheel1}, S-ECU_{wheel2}, S-ECU_{wheel3}, S-ECU_{wheel4}) is provided for each wheel module which jointly regulates a torque of the drive motor and the EMB. This makes it possible to achieve various cost and weight reductions both in the basic braking function and in control mode through simultaneous braking torque control via the driving dynamics system.

In a first step, the EMB can be substantially downsized due to the lower maximum torques required.

Compared to a 2-box solution, the EMB described herein is also much easier to apply and integrate into a central control of the driving dynamics system. Another advantage is independence from a brake manufacturer.

If the EMB is used in wheel modules according to the “Architecture III” of the driving dynamics system, the electric power steering EPS can be optionally omitted, because steering can be carried out via the wheel motors using different motor speeds. Even with a DDS variant C2 with EHB axle modules with piston-cylinder unit, the EHB can be substantially downsized, since lower maximum torques need to be achievable. Through joint braking using a traction motor and EHB, the friction brake can also be made substantially lighter and more cost-effective. Two pressure actuators thus achieve a lower cost level and also provide the necessary redundancy for SAE Level 5.

The use of a drum brake makes a further cost reduction possible.

If, in contrast to the abovementioned optimization 2, a variant C3 is used for the rear axle EHB with a simple pump (2-piston pump, gear pump), the pump generally cannot achieve the same control quality as a piston-cylinder unit; however, this is less critical on the rear axle. In addition, the pump can only generate the basic torque, while the traction motor(s) on the rear axle generate the controlled additional braking torque.

Here too, the use of a drum brake on the rear axle makes further cost reduction possible.

In a variant C4 with central EHB-Z, suitability for AD Level 3-4 has already been investigated, and even suitability for AD Level 5 has been described. An actuation unit can therefore be omitted.

The use of a drum brake on the rear axle makes an additional cost and weight reduction possible compared to an electromechanical brake unit EMB.

In summary, variants C2-C4 described herein achieve a cost level of an SAE Level 2 solution but meet all redundancy requirements for SAE Level 5. They can therefore be classified as effective solutions for autonomous driving at the highest level of development.

Compared to the EMB variants, the solutions offer the great advantage that components that are manufactured in large quantities, such as the hydraulic pressure supply or solenoid valves, and they are already available, making rapid series launch possible without high capital costs.

Another, supplementary example will now be described:

In the additional example, a Driving Dynamics System (DDS) or electric vehicle with a central control system with a Driving Dynamics System (DDS) with one of the DDS Architectures I, II, or III comprises
at least 1 wheel brake (RB1-RB4),
at least 1 electric traction motor (TM1, TM2, TM3, TM4) used both to drive and brake an axle or wheel,
at least 1 braking device (EMB, EHB) used to generate braking torque(s) on one or more wheel brakes,
a central processor (M-ECU_{domain}) by means of which both the at least one electric traction motor (TM1-TM4) and at least one braking device (EHB, EMB) are jointly controlled during braking processes via a control unit (M-ECU_{domain}, S-ECUₐₓₗₑ, S-ECU_{wheel}) and sends target signals to control units of the traction motor(s) (TM1-TM4) and braking device (EHB, EMB) for execution, a central processor with at least one of the core functions ABS, ESP, EBD, ASC, ACC, AEB, regeneration management with regenerative brakes via electric traction motors on multiple axles, and/or at least one of the core functions (A)-(G) is regulated or controlled via the central processor, wherein
with normal braking, braking is performed with the electric traction motor (TM1-TM4) even at high vehicle speeds (>80 km/h), and when braking via the electric traction motor (TM1-TM4), an EBD function (EBD=electronic brakeforce distribution to the front axle and rear axle) is implemented at the same time, and/or
in control mode (e.g., ABS, ESP) a braking torque is generated with at least one traction motor (TM1-TM4) and at least one EHB or EMB at the same time and a braking torque control is carried out on at least 3 wheels of a vehicle using a brake unit (EMB, EHB) and/or electric traction motor (TM1-TM4), such that a braking torque can be controlled on three wheels of a vehicle in any vehicle position.

1.-24. (canceled)

25. A driving dynamics system for a vehicle, comprising:
a wheel brake for dissipative braking of a wheel of the vehicle;
a brake unit which is associated with the wheel brake, and which is designed to generate a dissipative braking torque by means of the wheel brake;
at least one electric traction motor which is enabled to be controlled to generate a regenerative braking torque for at least one wheel or at least axle of the vehicle; and
a central control unit designed to control the brake unit and the electric traction motor for a braking function in combination with one another such that a combined braking torque is enabled to be generated by means of the brake unit and the electric traction motor;
wherein the braking function relates to a braking control process in which a basic braking torque and a controlled additional braking torque are controlled and/or regulated simultaneously and additively; and
wherein the braking function is selected from among the following functions:
automatic emergency brake, wherein a total braking torque is distributed unevenly between the rear axle and the front axle with electronic brake force distribution (EBD) control; or
anti-lock braking system (ABS) with basic braking torque assistance via the at least one traction motor.

26. The driving dynamics system according to claim 25, wherein the central control unit is designed to control the brake unit and the at least one electric traction motor in combination with one another for a function selected from among the following functions:
electronic stability program (ESP);
electronic brakeforce distribution (EBD);
anti-skid control (ASC);
distance control (Automated Cruise Control, ACC);
recuperation management for axle- or wheel-specific recuperation;
basic braking with thermal management;
yaw moment control in case of failure of a wheel brake; or
yaw moment intervention control for steering assistance.

27. The driving dynamics system according to claim 25, wherein the brake unit comprises an electric motor drive and is embodied as an electrohydraulic brake unit or as an electromechanical brake unit.

28. The driving dynamics system according to claim 25, wherein during the braking control process, a total braking torque is built up or reduced simultaneously by the basic braking torque and the controlled additional braking torque.

29. The driving dynamics system according to claim 25, wherein the central control unit is configured redundantly with three microcontrollers to implement a 2-out-of-3 architecture;
and/or
the central control unit is connected to the brake unit and the electrical traction motor via multiple data lines;
and/or
the central control unit includes a microcontroller and a memory dimensioned in the gigabyte range, such that an automated application is enabled to be carried out via learning algorithms or artificial intelligence (AI), both before the vehicle is put into operation and subsequently during normal operation without faults, as well as adapted operation when a fault occurs;
and/or
the central control unit is coupled to at least one brake unit control unit of the brake unit.

30. The driving dynamics system according to claim 25, wherein the central control unit is configured to receive data from wheel speed sensors of the wheels of the vehicle and/or further sensor signals, wherein the further sensor signals are provided by yaw moment sensors, acceleration sensors, and/or weight sensors;
and/or
the central control unit is configured to transmit target signals to a motor control unit of the at least one traction motor and to a brake unit control unit of the brake unit in the braking function.

31. The driving dynamics system according to claim 25, wherein the central control unit is configured to control the at least one electric traction motor for regenerative braking of the vehicle when the vehicle speed is above 80 km/h for braking in normal operation;
wherein during regenerative braking, an electronic brakeforce distribution (EBD) is simultaneously implemented on a front axle and a rear axle of the vehicle;
wherein 20-40% of a total braking torque acts on the rear axle and 60-80% of the total braking torque acts on the front axle of the vehicle, wherein a total braking torque at the rear axle is provided exclusively by the at least one electric traction motor.

32. The driving dynamics system according to claim 25, wherein the wheel brake of the wheel of the vehicle is associated with its own brake unit, wherein the brake unit is electromechanical; wherein for two wheels of the vehicle, including the wheel of the vehicle, the brake unit associated with the wheel brake and a brake unit associated with a second wheel brake and a respective electric traction motor are integrated into respective wheel modules; wherein in case of failure of a brake unit or electric traction motor of one of the wheel modules, the wheel module that has not failed takes over generating braking torque and controlling braking torque for ABS.

33. The driving dynamics system according to claim 25, wherein a common electrohydraulic brake unit is associated with wheel brakes of two wheels of a front axle of the vehicle,
wherein all brake units have individual control units and are able to be controlled by an electrical control signal from the central control unit; and
wherein a hydraulic connection is provided to a brake unit for generating braking torque at at least one wheel of a rear axle of the vehicle by means of a hydraulic brake unit, wherein the hydraulic connection is switchable by means of a solenoid valve.

34. The driving dynamics system according to claim 25, wherein a central brake unit is associated with wheel brakes of four wheels of the vehicle;
wherein the central brake unit has an electrohydraulic design;
wherein the central brake unit has its own control unit and is able to be controlled exclusively by the central control unit via an electrical control signal; and
wherein the central brake unit further is redundantly configured with two power supplies and/or two control units.

35. The driving dynamics system according to claim 25, wherein a common electrohydraulic brake unit is associated with wheel brakes of two wheels of a first axle of the vehicle;
wherein for the wheel brakes of the first axle, wheel-specific dissipative braking torques are adjustable by means of solenoid valves in hydraulic lines between the electrohydraulic brake unit and the wheel brakes of the first axle;
wherein the electrohydraulic brake unit is also connectable via a hydraulic line to wheel brakes of two wheels of a second axle of the vehicle; and
wherein common, non-wheel-specific dissipative braking torques are able to be set for the wheel brakes of the second axle.

36. The driving dynamics system according to claim 25, wherein the central control unit is designed to distribute the basic braking torque and the controlled additional braking torque to the brake unit and the at least one electric traction motor as a function of vehicle deceleration and/or as a function of a coefficient of friction of the road.

37. The driving dynamics system according to claim 25, wherein the central control unit includes redundant microcontrollers and a memory dimensioned in the gigabyte range, and is designed to acquire sensor data during vehicle operation and to adapt control of the braking function on the basis of the acquired sensor data by means of an artificial intelligence method that is capable of being implemented by the redundant microcontrollers of the central control unit, wherein adaptation of the control of the braking function is performed when the vehicle is parked, based on the acquired sensor data, a characteristic map is determined, wherein the characteristic map is adaptable based on the acquired sensor data and the artificial intelligence process if a deviation from a current characteristic map is detected.

38. A driving dynamics system for a vehicle, comprising:
at least one electric traction motor controllable to generate a regenerative braking torque for at least one wheel or axle of the vehicle; and
a central control unit configured to control the at least one electric traction motor for a braking function, wherein the braking function relates to a braking control process of an anti-lock braking system (ABS) braking control or an electronic stability program (ESP) braking control wherein the central control unit is designed to carry out the braking function when braking on snow, ice, and/or wet roads, with low to moderate decelerations of less than 0.5 m/s²,
wherein the central control unit is configured to carry out the braking function by means of at least one traction motor of at least one axle of the vehicle.

39. A vehicle with the driving dynamics system according to claim 25.

40. A method for operating a driving dynamics system having at least one brake unit configured to generate a dissipative braking torque and at least one electric traction motor configured to generate a regenerative braking torque for at least one wheel or axle of the vehicle, and a central control unit configured to control the at least one brake unit and the at least one electric traction motor to implement a braking function, wherein the method comprises:
generating a combined braking torque is generated by means of the at least one braking unit and the at least one electric traction motor, wherein the braking function relates to a braking control process in which a basic braking torque and a controlled additional braking torque are controlled and/or regulated simultaneously and additively, including controlling the at least one brake unit and the at least one electric traction motor to respectively or in combination generate the basic braking torque and the controlled additional braking torque, wherein the braking function is selected from among the following functions:
automatic emergency brake (AEB), wherein a total braking torque is distributed unevenly between a rear axle and a front axle of the vehicle; or
anti-lock braking system (ABS) with basic braking torque assistance via the at least one traction motor.
